(19) United States
(12) Patent Application Publication
(10) Pub. No.: US 2025/0102643 A1
(43) Pub. Date: Mar. 27, 2025

(54) RANGE IMAGING DEVICE AND RANGE IMAGING METHOD

(71) Applicant: TOPPAN HOLDINGS INC., Tokyo (JP)

(72) Inventors: Kazuto YAMAMOTO, Taito-ku (JP); Tomohiro NAKAGOME, Taito-ku (JP); Tetsuo OOSONO, Taito-ku (JP); Takeshi KAWABATA, Taito-ku (JP); Yuya SHIRAKAWA, Taito-ku (JP)

(73) Assignee: TOPPAN HOLDINGS INC., Tokyo (JP)

(21) Appl. No.: 18/972,321

(22) Filed: Dec. 6, 2024

Related U.S. Application Data
(63) Continuation of application No. PCT/JP2023/021392, filed on Jun. 8, 2023.

(30) Foreign Application Priority Data
Jun. 8, 2022 (JP) 2022-092847
Nov. 30, 2022 (JP) 2022-191128
Nov. 30, 2022 (JP) 2022-191493

(51) Int. Cl. G01S 7/4863; G01S 7/484; G01S 17/894

(52) U.S. Cl. CPC G01S 7/4863; G01S 7/484; G01S 17/894

(57) ABSTRACT

A range imaging device includes a light source unit that emits light pulses to an object, a light-receiving unit including pixel circuits each including a photoelectric conversion element that generates charge according to incident light and charge storage units that integrates the charge, a pixel drive circuit that distributes the charge to the charge storage units for integration therein, and a charge discharge unit that discharges the charge, and a distance calculation unit that calculates a distance to the object. The light pulses include structured light including patterns of dot light, and at least one first pattern of dot light among the patterns of dot light has an elliptical shape in which a ratio of a major axis length to a minor axis length is a threshold or more.

### CROSS-REFERENCE TO RELATED APPLICATIONS

The present application is a continuation of and claims the benefit of priority to International Application No. PCT/JP2023/021392, filed Jun. 8, 2023, which is based upon and claims the benefit of priority to Japanese Application No. 2022-092847, filed Jun. 8, 2022, Japanese Application No. 2022-191493, filed Nov. 30, 2022 and Japanese Application No. 2022-191128, filed Nov. 30, 2022. The entire contents of these applications are incorporated herein by reference.

### BACKGROUND OF THE INVENTION

### Field of the Invention

The present invention relates to range imaging devices and range imaging methods.

### Description of Background Art

JP 4235729 B describes a time of flight (hereinafter referred to as “TOF”) type range imaging device. The entire contents of this publication are incorporated herein by reference.

### SUMMARY OF THE INVENTION

According to one aspect of the present invention, a range imaging device includes a light source that emits light pulses to an object, a light-receiving unit including pixel circuits, a pixel drive circuit, and a charge discharge unit, and a distance calculation unit including circuitry that calculates a distance to the object. The pixel circuits are formed in a two-dimensional matrix, each of the pixel circuits includes a photoelectric conversion element that generates charge according to incident light and charge storage units that integrate the charge, the pixel drive circuit distributes the charge to the charge storage units at an integration timing synchronized with the emission of the light pulses, the charge discharge unit discharges the charge during a period other than the integration timing, the circuitry of the distance calculation unit calculates the distance to the object based on an amount of the charge integrated in the charge storage units, and the light pulses include structured light having patterns of dot light such that the patterns of dot light includes at least one first pattern of dot light having an elliptical shape in which a ratio of a major axis length to a minor axis length is equal to a threshold or more.

According to another aspect of the present invention, a range imaging device includes a light source that emits light pulses to an object, a light-receiving unit including pixel circuits, a pixel drive circuit, and a charge discharge unit, and a distance calculation unit including circuitry that calculates a distance to the object. The pixel circuits are formed in a two-dimensional matrix, each of the pixel circuits includes a photoelectric conversion element that generates charge according to incident light and charge storage units that integrate the charge, the pixel drive circuit distributes the charge to the charge storage units at an integration timing synchronized with the emission of the light pulses according to a frame cycle, the charge discharge unit discharges the charge during a period other than the integration timing, the circuitry of the distance calculation unit calculates a distance to the object based on an amount of the charge integrated in the charge storage units, the light source emits the light pulses including structured light including periodically formed lines of light such that the light pulses include the periodically formed lines of light in two directions intersecting with each other, the frame cycle includes subframe cycles with different integration periods for integrating the charge in the charge storage units, and the circuitry of the distance calculation unit calculates the distance to the object using a subframe cycle in which the amount of the charge has not exceeded a preset threshold among the subframe cycles.

According to yet another aspect of the present invention, a range imaging device includes a light source that emits light pulses to an object, a light-receiving unit including pixel circuits, a pixel drive circuit, and a charge discharge unit, and a distance calculation unit including circuitry that calculates a distance to the object. The pixel circuits are formed in a two-dimensional matrix, each of the pixel circuits includes a photoelectric conversion element that generates charge according to incident light and charge storage units that integrate the charge, the pixel drive circuit distributes the charge to the charge storage units at an integration timing synchronized with the emission of the light pulses according to a frame cycle, the charge discharge unit discharges the charge during a period other than the integration timing, the circuitry of the distance calculation unit calculates the distance to the object based on an amount of the charge integrated in the charge storage units, the light source emits lines of light as the light pulses including structured light including periodically formed lines of light, the light pulses include the lines of light in two directions intersecting with each other, the frame cycle includes subframe cycles including the formed lines of light with different directions, and the circuitry of the distance calculation unit calculates the distance to the object based on the amount of the charge integrated according to the subframe cycles including the lines of light with different directions.

According to still another aspect of the present invention, a range imaging device includes a light source that emits light pulses to an object, a light-receiving unit including pixel circuits, a pixel drive circuit, and a charge discharge unit, and a distance calculation unit including circuitry that calculates a distance to the object. The pixel circuits are formed in a two-dimensional matrix, each of the pixel circuits includes a photoelectric conversion element that generates charge according to incident light and charge storage units that integrate the charge, the pixel drive circuit distributes the charge to the charge storage units at an integration timing synchronized with the emission of the light pulses according to a frame cycle, the charge discharge unit discharges the charge during a period other than the integration timing, the circuitry of the distance calculation unit calculates the distance to the object based on an amount of the charge integrated in the charge storage units, the light source emits the light pulses including structured light including periodically formed lines of light such that the light pulses include the periodically formed lines of light in two directions intersecting with each other, and the pixel circuits include a first pixel circuit formed at a position corresponding to a position of receiving reflected light from the object arising from the periodically formed lines of light emitted in an intersecting manner and having a sensitivity to the reflected light that is lower than a sensitivity of each of second pixel circuits at other positions.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram illustrating a schematic configuration of a range imaging device according to a first embodiment;

FIG. 2 is a block diagram illustrating a schematic configuration of a range imaging sensor according to the first embodiment;

FIG. 3 is a circuit diagram illustrating an example of a configuration of a pixel according to the first embodiment;

FIG. 4 is a diagram illustrating an example in which patterns of dot light are applied to an object according to the first embodiment;

FIG. 5 is a diagram illustrating an example in which patterns of dot light are applied to an object according to the first embodiment;

FIG. 6 is a diagram illustrating an example in which dot light is applied to an object according to the first embodiment;

FIG. 7 is a diagram illustrating an example in which dot light is applied to an object according to the first embodiment;

FIG. 8 is a diagram illustrating an example in which dot light is applied to an object according to the first embodiment;

FIG. 9 is a block diagram illustrating an example of a range imaging device according to a second embodiment;

FIG. 10 is a block diagram illustrating an example of a range imaging sensor according to the second embodiment;

FIG. 11 is a block diagram illustrating an example of a pixel circuit according to the second embodiment;

FIG. 12 is a first diagram illustrating an example of a line of light according to the second embodiment;

FIG. 13 is a second diagram illustrating an example of a line of light according to the second embodiment;

FIG. 14 is a third diagram illustrating an example of lines of light according to the second embodiment;

FIG. 15 is a diagram illustrating an example of a frame cycle according to the second embodiment;

FIG. 16 is a flow chart illustrating an example of an operation of the range imaging device according to a second embodiment;

FIG. 17 is a block diagram illustrating an example of a range imaging device according to a third embodiment;

FIG. 18 is a diagram illustrating an example of a frame cycle according to the third embodiment;

FIG. 19 is a flow chart illustrating an example of an operation of the range imaging device according to the third embodiment;

FIG. 20 is a diagram illustrating a modification of the frame cycle according to the third embodiment;

FIG. 21 is a flow chart illustrating a modification of the operation of the range imaging device according to the third embodiment; and

FIG. 22 is a diagram illustrating an example of a range imaging device according to a fourth embodiment.

### DETAILED DESCRIPTION OF THE EMBODIMENTS

Embodiments will now be described with reference to the accompanying drawings, wherein like reference numerals designate corresponding or identical elements throughout the various drawings.

### First Embodiment

Referring to the drawings, a range imaging device according to a first embodiment will be described below.

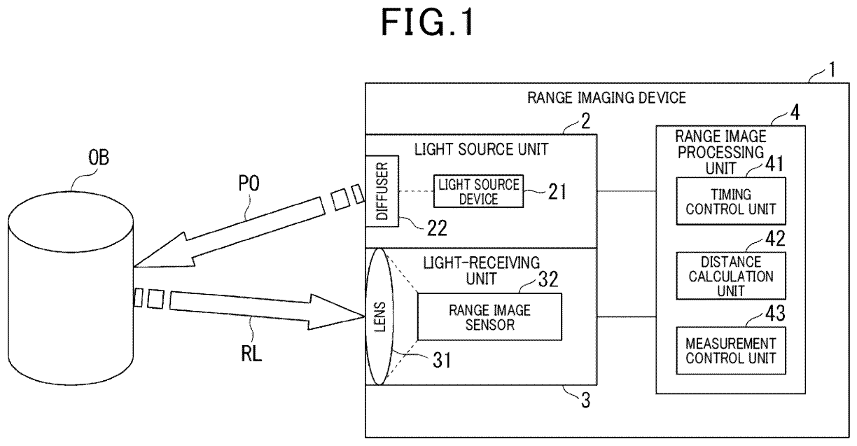

FIG. 1 is a block diagram illustrating a schematic configuration of the range imaging device according to the first embodiment. A range imaging device 1 includes, for example, a light source unit 2, a light-receiving unit 3, and a range image processing unit 4. FIG. 1 also illustrates an object OB the distance to which is measured by the range imaging device 1.

The light source unit 2 emits light pulses PO into a space as a measurement target where the object OB is present whose distance is to be measured by the range imaging device 1 under the control of the range image processing unit 4. The light source unit 2 may be, for example, a surface emitting type semiconductor laser module such as a vertical cavity surface emitting laser (VCSEL). The light source unit 2 includes a light source device 21 and a diffuser 22.

The light source device 21 is a light source which emits laser light in the near infrared wavelength band (e.g., wavelength band of 850 nm to 940 nm) serving as the light pulses PO to be emitted to the object OB. The light source device 21 may be, for example, a semiconductor laser light emitting device. The light source device 21 emits pulsed laser light in response to the control of a timing control unit 41.

The diffuser 22 is an optical component which diffuses laser light in the near infrared wavelength band emitted from the light source device 21 over the emission surface area of the object OB. Pulsed laser light diffused by the diffuser 22 is emitted as the light pulses PO and applied to the object OB.

The light-receiving unit 3 receives reflected light RL arising from reflection of the light pulses PO from the object OB, which is the object whose distance is to be measured by the range imaging device 1, and outputs a pixel signal according to the received reflected light RL. The light-receiving unit 3 includes a lens 31 and a range imaging sensor 32.

The lens 31 is an optical lens that focuses the incident reflected light RL on the range imaging sensor 32. The lens 31 outputs the incident reflected light RL toward the range imaging sensor 32, so that the light can be received by (be incident on) pixels provided to the light-receiving area of the range imaging sensor 32.

The range imaging element sensor 32 is an imaging element used for the range imaging device 1. The range imaging sensor 32 includes pixels in a two-dimensional light-receiving area. Each pixel of the range imaging sensor 32 includes one photoelectric conversion element, charge storage units corresponding to the single photoelectric conversion element, and components distributing charge to the charge storage units. In other words, each pixel is an imaging element with a distribution structure distributing charge to the multiple charge storage units for integration therein.

In response to the control of the timing control unit 41, the range imaging sensor 32 distributes charge, which has been generated by the photoelectric conversion element, to the charge storage units. Also, the range imaging sensor 32 outputs pixel signals according to the amount of charge distributed to the charge storage units. The range imaging sensor 32, in which the pixels are formed in a two-dimensional matrix, outputs single-frame pixel signals corresponding to the respective pixels.

The range image processing unit 4 controls the range imaging device 1 and calculates the distance to the object OB. The range image processing unit 4 includes the timing control unit 41, a distance calculation unit 42, and a measurement control unit 43.

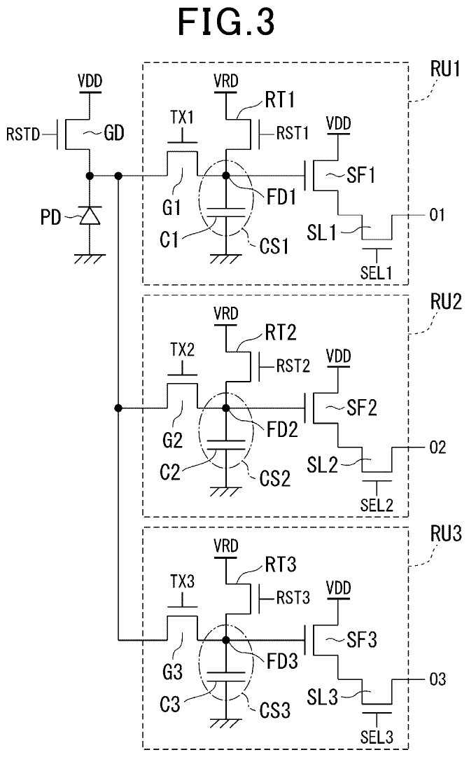

The timing control unit 41 controls timing of outputting various control signals required for measurement, in response to the control of the measurement control unit 43. The various control signals include, for example, a signal for controlling emission of the light pulses PO, a signal for distributing the reflected light RL to the charge storage units for integration therein, a signal for controlling the number of integrations per frame, and other signals. The number of integrations refers to the number of repetitions of the processing for distributing charge to charge storage units CS for integration therein (see FIG. 3). The product of the number of integrations and the duration (duration for integration) for integrating charge in the charge storage units in each charge distribution and integration processing is an exposure time.

The distance calculation unit 42 outputs distance information indicating the distance to the object OB calculated based on the pixel signals outputted from the range imaging sensor 32. The distance calculation unit 42 calculates a delay from when the light pulses PO are emitted until when the reflected light RL is received, based on the charge integrated in the charge storage units CS. The distance calculation unit 42 calculates the distance to the object OB according to the calculated delay.

The measurement control unit 43 controls the timing control unit 41. For example, the measurement control unit 43 may set the number of integrations and duration for integration in a single frame and may control the timing control unit 41 so that an image is captured according to the settings.

With this configuration, in the range imaging device 1, the light source unit 2 emits the light pulses PO in the near infrared wavelength band toward the object OB, the light-receiving unit 3 receives the reflected light RL arising from reflection of the light pulses PO from the object OB, and the range image processing unit 4 outputs distance information indicating the measured distance to the object OB.

Although FIG. 1 shows a range imaging device 1 including the range image processing unit 4 inside thereof, the range image processing unit 4 may be a component provided external to the range imaging device 1.

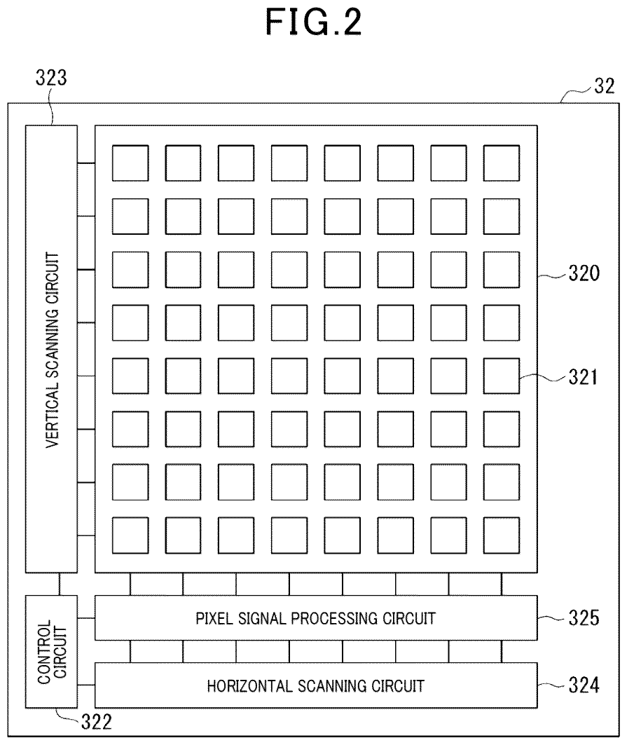

Referring now to FIG. 2, the configuration of the range imaging sensor 32 used as an imaging element in the range imaging device 1 will be described. FIG. 2 is a block diagram illustrating a schematic configuration of an imaging element (range imaging sensor 32) used in the range imaging device 1 according to the first embodiment.

As shown in FIG. 2, the range imaging sensor 32 includes, for example, a light-receiving area 320 where pixels (pixel circuits) 321 are formed, a control circuit 322, a vertical scanning circuit 323 performing a distribution operation, a horizontal scanning circuit 324, and a pixel signal processing circuit 325.

The light-receiving area 320 is an area where the pixels 321 are formed. FIG. 2 illustrates an example in which the pixels 321 are formed in a two-dimensional matrix of 8 rows and 8 columns. The pixels 321 integrate charge corresponding to the intensity of received light. The control circuit 322 comprehensively controls the range imaging sensor 32. The control circuit 322 controls, for example, the operation of the components of the range imaging sensor 32 according to the instructions from the timing control unit 41 of the range image processing unit 4. The components of the range imaging sensor 32 may be directly controlled by the timing control unit 41. In this case, the control circuit 322 can be omitted.

The vertical scanning circuit 323 is a circuit controlling the pixels 321 formed in the light-receiving area 320 row by row in response to the control of the control circuit 322. The vertical scanning circuit 323 causes the pixel signal processing circuit 325 to output a voltage signal corresponding to the amount of charge integrated in charge storage units CS of each pixel 321. In this case, the vertical scanning circuit 323 distributes charge converted by the photoelectric conversion element to the charge storage units of each pixel 321 for integration therein. In other words, the vertical scanning circuit 323 is an example of the pixel drive circuit.

The pixel signal processing circuit 325 is a circuit performing predetermined signal processing (e.g., noise suppression processing and A/D conversion processing) on voltage signals outputted from the pixels 321 of each column to the corresponding one of vertical signal lines, in response to the control of the control circuit 322.

The horizontal scanning circuit 324 is a circuit sequentially outputting the signals outputted from the pixel signal processing circuit 325 to horizontal signal lines, in response to the control of the control circuit 322. Thus, the pixel signals corresponding to the amount of charge integrated for a single frame are sequentially outputted to the range image processor 4 via the horizontal signal lines.

The following description is provided assuming that the pixel signal processing circuit 325 performs A/D conversion processing and the pixel signals are digital signals. Referring now to FIG. 3, the configuration of the pixels 321 formed in the light-receiving area 320 of the range imaging sensor 32 will be described. FIG. 3 is a circuit diagram illustrating an example of a configuration of a pixel 321 formed in the light-receiving area 320 of the range imaging sensor 32 according to the first embodiment. FIG. 3 shows an example of a configuration of one of the pixels 321 formed in the light-receiving area 320. The pixel 321 is an example of a configuration with three pixel signal readouts.

The pixel 321 includes one photoelectric conversion element PD, a drain gate transistor (charge discharge transistor) GD (charge discharge unit, charge discharge section), and three pixel signal readouts RU which output voltage signals from corresponding output terminals O. Each of the pixel signal readouts RU includes a readout gate transistor G, a floating diffusion FD, a charge storage capacitor C, a reset gate transistor RT, a source follower gate transistor SF, and a selection gate transistor SL. In each pixel signal readout RU, the floating diffusion FD and the charge storage capacitor C constitutes a charge storage unit CS.

In FIG. 3, numerals 1, 2 and 3 are added to the reference signs RU of the three pixel signal readouts to distinguish them from each other. Similarly, the numerals added to the three pixel signal readouts RU are also added to the components included in the respective pixel signal readouts RU to specify the pixel signal readouts RU to which the respective components correspond.

In the pixel circuit 321 shown in FIG. 3, the pixel signal readout RU1 that outputs a voltage signal from an output terminal O1 includes a readout gate transistor G1, a floating diffusion FD1, a charge storage capacitor C1, a reset gate transistor RT1, a source follower gate transistor SF1, and a selection gate transistor SL1. In the pixel signal readout RU1, the floating diffusion FD1 and the charge storage capacitor C1 constitute a charge storage unit CS1. The pixel signal readout units RU2 and RU3 also have the same configuration.

The configuration of each pixel formed in the range imaging sensor 32 is not limited to the configuration, as shown in FIG. 3, provided with three pixel signal readouts RU, but may only need to be a configuration including pixel signal readouts RU. In other words, the number of the pixel signal readouts RU (charge storage units CS) included in each pixel of the range imaging sensor 32 may be two or may be four or more.

The pixel 321 shown in FIG. 3 is a configuration example in which the charge storage unit CS is constituted of the floating diffusion FD and the charge storage capacitor C. However, the charge storage unit CS may have any configuration as long as it is constituted of at least the floating diffusion FD, and the pixel 321 does not necessarily have to include the charge storage capacitor C.

The pixel 321 shown in FIG. 3 is a configuration example including the drain gate transistor GD; however, if the charge stored (remaining) in the photoelectric conversion element PD is not required to be discarded, the drain gate transistor GD does not necessarily have to be included.

The photoelectric conversion element PD is an embedded photodiode which performs photoelectric conversion for incident light, generates charge corresponding to the incident light, and integrates the generated charge. The photoelectric conversion element PD may be structured as desired. The photoelectric conversion element PD may be, for example, a PN photodiode including a P-type semiconductor and an N-type semiconductor joined together, or may be a PIN photodiode including an I-type semiconductor sandwiched between a P-type semiconductor and an N-type semiconductor. Alternatively, without being limited to a photodiode, the photoelectric conversion element PD may be, for example, a photogate-type photoelectric conversion element.

In the pixel 321, light which is incident at an integration timing synchronized with the emission timing of the light pulses PO is converted to charge by the photoelectric conversion element PD, and the converted charge is distributed to the three charge storage units CS for integration therein. Light which is incident on the pixel 321 at the timing other than the integration timing is converted to charge by the photoelectric conversion element PD, and the converted charge is discharged from the drain gate transistor GD so as not to be integrated in the charge storage units CS. Thus, integration of charge at the integration timing and discarding of charge at the timing other than the integration timing are repeated over a single frame, and then a readout period is provided. In the readout period, the electrical signals corresponding to the single-frame charge integrated in the charge storage units CS are outputted to the distance calculation unit 42 by the horizontal scanning circuit 324.

Using the fact that the charge corresponding to the reflected light RL component is distributed to and integrated in two charge storage units CS at a ratio according to the delay Td before the reflected light RL is incident on the range imaging device 1, the distance calculation unit 42 calculates a delay Td using the following Formula (1). The distance calculation unit 42 multiplies the delay Td calculated through Formula (1) by the speed of light (velocity) to calculate a round-trip distance to the object OB. The distance calculation unit 42 calculates the distance to the object OB by halving the round-trip distance calculated above. Formula (1) assumes that the amount of charge corresponding to the external light component is integrated in the charge storage unit CS1 and the amount of charge corresponding to the reflected light RL component is distributed to and integrated in the charge storage units CS2 and CS3.

Td=To×(Q3−Q1)/(Q2+Q3−2×Q1) (1)

In the formula, To represents a period during which the light pulses PO are emitted, Q1 represents the charge integrated in the charge storage unit CS1, Q2 represents the charge integrated in the charge storage unit CS2, and Q3 represents the charge integrated in the charge storage unit CS3.

In the first embodiment, dot light is used as light emitted from the light source unit 2. For example, a dot light source may include structured light including periodically formed patterns of dot light.

Using a dot light source, non-uniform local light pulses PO are applied to the object OB. Using dot light, the power of emitted light (emission intensity per unit area) can be increased without increasing the light source output, and the reach of the emitted light can be increased to thereby increase the measurable distance. However, using a dot light source, distance cannot be measured for the area where the dot light is not applied, raising an issue of low resolution.

To address this issue, in the first embodiment, patterns of dot light each having an elliptical shape are used as the light pulses PO. For example, the light source unit 2 may include light source elements each of which can independently emit the light pulses PO (patterns of dot light each having an elliptical shape).

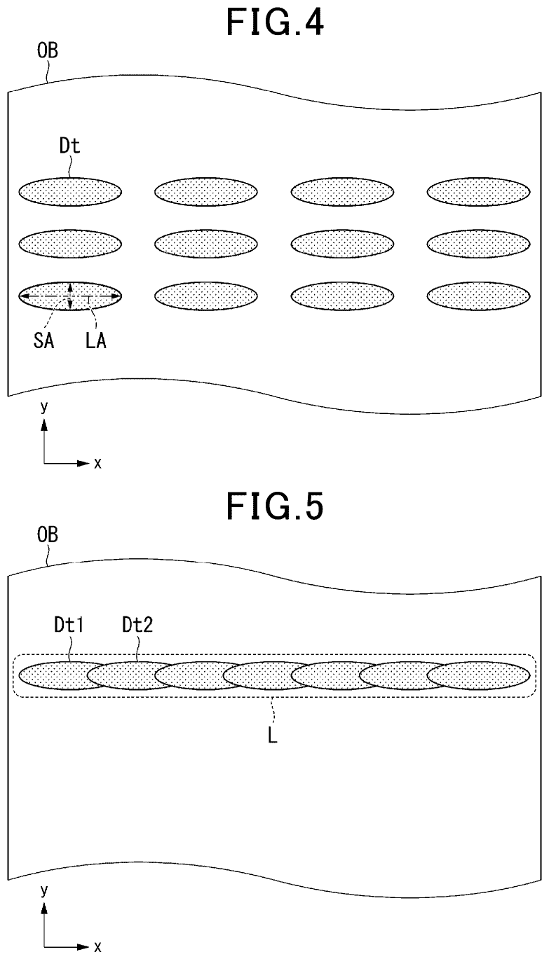

FIG. 4 is a diagram illustrating an example of the dot light according to the first embodiment. FIG. 4 schematically illustrates a state in which dot light Dt as the light pulses PO has been applied to the object OB by the range imaging device 1. As shown in FIG. 4, each pattern of dot light Dt has an elliptical shape in which the ratio of a major axis length LA to a minor axis length SA is a threshold or more. The threshold herein may be set to any value. For example, each pattern of a dot light source may have an elliptical shape in which the ratio of the major axis length LA to the minor axis length SA is 2 or greater. Thus, in the first embodiment, use of elliptical patterns of dot light Dt can reduce the area in the object OB where no light is applied, compared to the case where circular patterns of dot light Dt are used. Accordingly, deterioration in resolution can be suppressed Referring to FIGS. 5 to 8, variations of the dot light Dt will be described. FIGS. 5 to 8 are diagrams illustrating other examples of the dot light according to the first embodiment.

FIG. 5 shows a state in which part of a pattern of dot light Dt is overlapped with part of another pattern of dot light Dt. In this way, in the first embodiment, at least part of a dot light pattern Dt1 may be formed to overlap with at least part of another dot light pattern Dt2 adjacent to the dot light pattern Dt1 in the major axis direction. Thus, the area where no light is applied in the object OB can be further reduced.

In the example described referring to FIG. 5, the patterns of dot light are overlapped in the major axis direction; however, they may be overlapped in the minor axis direction. Alternatively, the patterns of dot light may be overlapped in any axis direction set obliquely to the major or minor axis. By allowing at least part of a pattern of dot light Dt to overlap with another pattern of dot light Dt, the area where no light is applied can be reduced and thus an effect similar to the effect described above can be achieved.

As shown in FIG. 5, by applying light with patterns of dot light Dt overlapped in the major axis direction, the light pulses PO can be formed into linear light. In the following description, the light emitted with patterns of dot light Dt overlapped in the major axis direction is referred to as a line of light L. The line of light may be used instead of or together with the dot light source of the first embodiment.

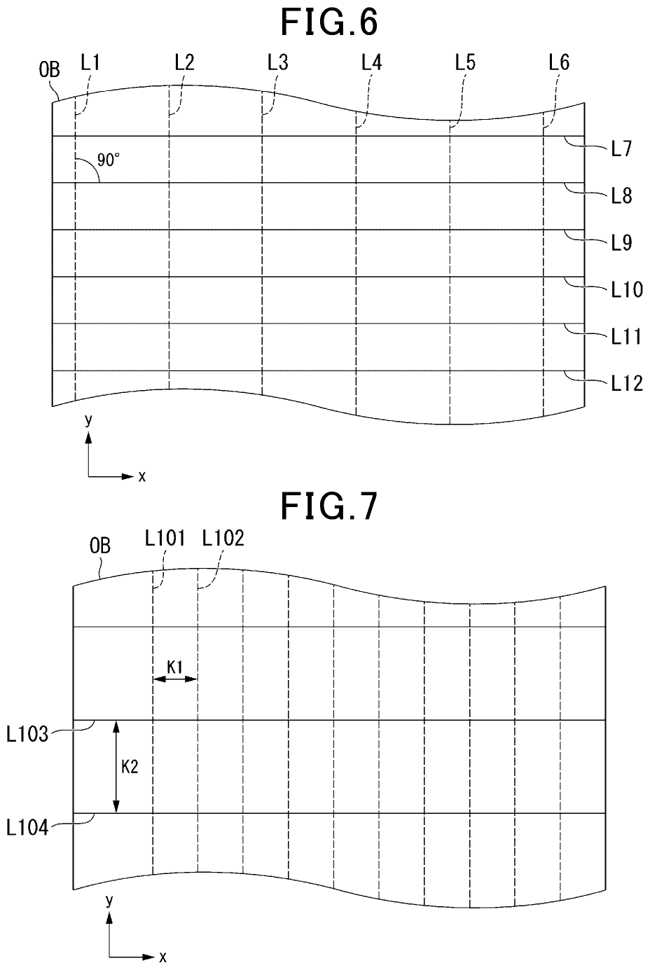

FIG. 6 shows a state in which lines of light L are intersected with each other. Thus, in the first embodiment, lines of light L may be differently directed. Specifically, the elliptical patterns of dot light Dt may be formed to have different major axis directions.

Thus, light can be emitted in a mesh pattern to the object OB, and the area where no light is applied in the object OB can be further reduced.

If all the lines of light are parallel to each other, light lines may be overlapped with each other for some reason and the area where light is applied in the object OB may be reduced. However, if the lines of light L have different directions, overlapping of these lines of light L can be avoided except for the intersections. Accordingly, this can avoid reduction of the area where light is applied in the object OB.

FIG. 6 shows an example in which the directions of a group of lines of light L1 to L6 are perpendicular to the directions of a group of lines of light L7 to L12, i.e., the former group intersects the latter group at 90 degrees. Thus, the elliptical patterns of dot light Dt emitted from one of at least two of the light source elements may be formed to have a major axis direction perpendicular to the major axis direction of the elliptical patterns of dot light emitted from the other thereof.

The angle between the two lines of light L is not limited to 90 degrees, but the directions of at least two lines of light L may only need to be different from each other. In other words, the angle between the two lines of light L may only need to be greater than 0 degrees and less than or equal to 90 degrees.

FIG. 7 shows a state in which parallel lines of light L have different intervals therebetween. For example, an interval K1 between lines L101 to L102 of light may be different from an interval K2 between lines L103 to L104 of light.

Thus, in the first embodiment, the lines of light L may have intervals different between the vertical and horizontal directions. Specifically, when the elliptical patterns of dot light Dt with the major axes oriented in the same direction emitted from a first light source element group composed of at least two light source elements have a first interval in the minor axis direction, and the elliptical patterns of dot light Dt with the major axes oriented in the same direction emitted from a second light source element group different from the first light source element group and composed of at least two light source elements have a second interval in the minor axis direction, the first interval and the second interval may be different. Thus, measurement can be performed for the object OB distinguishing the area where the distance is finely measured, from the area where the distance is coarsely measured.

For example, if an object OB moving in the horizontal direction is the target of measurement, the resolution of the distance measurement may be increased for the horizontal direction and decreased for the vertical direction. In this case, light may be emitted decreasing the interval between the lines of light L in the vertical direction, and increasing the interval between the lines of light L in the horizontal direction. Thus, the area where the distance is desired to be measured with a fine interval can be measured with high resolution.

The group of lines of light L in the vertical direction, or the group of lines of light L in the horizontal direction, may have uneven intervals. For example, this may be applied to the case of measuring an object with a small height, such as the case of measuring an object with low resolution for the upper part thereof and with high resolution for the center to lower part thereof. In this case, light may be emitted so that, of the lines of light L in the horizontal direction, those for the upper part will have a larger interval, and those for the center to lower part will have a smaller interval. Thus, the region where the object OB is present can be measured with high resolution.

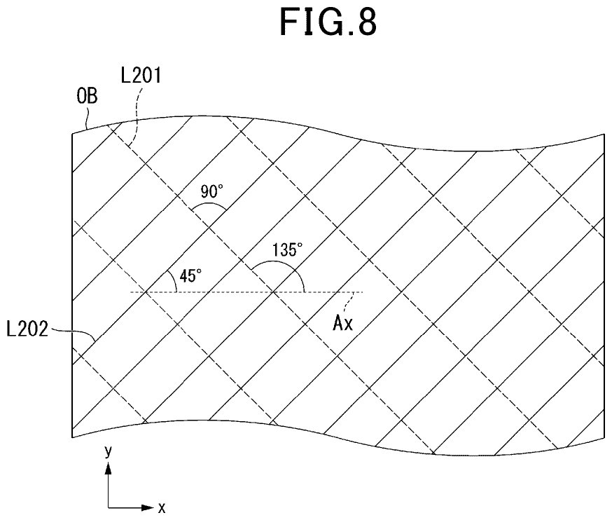

FIG. 8 shows a state in which lines of light L are emitted in oblique directions, which are different from the vertical direction (perpendicular direction) or the horizontal direction, relative to the surface (ground) on which the range imaging device 1 is installed. For example, the angle between a line of light L201 and a line segment Ax in the x-axis direction (horizontal direction) may be 135 degrees. Also, the angle between a line of light L202 and the line segment Ax may be 45 degrees.

Thus, in the first embodiment, lines of light L may be emitted in oblique directions relative to the ground. Specifically, the elliptical patterns of dot light emitted from two light source elements among the multiple light source elements may have major axis directions at an angle of 45 degrees or 135 degrees relative to the surface on which the imaging device is installed.

Thus, in the first embodiment, lines of light L may be emitted in oblique directions relative to the ground. Specifically, the major axis direction of each of the elliptical patterns of dot light Dt emitted from two light source elements among the multiple light source elements may be oblique, instead of perpendicular or parallel, relative to the surface on which the range imaging device 1 is installed.

If lines of light L perpendicular to the ground and lines of light L parallel to the ground are attempted to be achieved by combining a light source and a diffuser, diffusers are required to be separately prepared for the vertical and horizontal directions if the field of illumination (FOI) is different between the horizontal and vertical directions. In this regard, if two oblique lines of light L are to be orthogonalized, two diffusers may be prepared with the same design for obliquely emitting lines of light L, and mounted with the top and bottom reversed between the two diffusers, so that the two oblique lines of light L can be perpendicular to each other. Accordingly, by obliquely intersecting lines of light at right angles, the device cost for the light source unit 2 can be reduced even more, compared to intersecting horizontal and vertical lines of light at right angles. In the first embodiment, uniform-diffusion light source elements may be combined with the dot light Dt. The uniform-diffusion light source elements irradiate a surface with uniform light. Using the uniform-diffusion light source elements, the object OB can be irradiated with uniform light.

Thus, in the range imaging device 1 according to the first embodiment, different light sources can be used depending on the distance to the object OB. For example, when measuring a short distance, i.e., the distance to a relatively close object OB, the uniform-diffusion light source may be used. Thus, if the object OB is closely located and light with sufficient intensity can be applied to the object OB without using the dot light Dt, the distance can be measured using the uniform-diffusion light source with high resolution, without reducing the resolution due to use of the dot light Dt. However, when measuring a long distance, i.e., the distance to a relatively distant object OB, a dot light source may be used. Thus, even when the object OB is present in the distance, the intensity of the reflected light RL can be increased using the dot light Dt and the area where no light is applied in the object OB can be reduced as much as possible by forming the dot light Dt into elliptical patterns, so that the distance can be measured with the deterioration in resolution suppressed. Accordingly, the dot light and the diffuse light source can be appropriately used depending on the measurement conditions according to the distance to the object OB, and degradation in resolution can be suppressed in both of the short and long distance cases.

As described above, in the range imaging device 1 according to the first embodiment, the light pulses PO include structured light composed of multiple patterns of dot light Dt. Of the multiple patterns of dot light Dt, at least one pattern of dot light Dt1 (first pattern of dot light) has an elliptical shape where the ratio of the major axis length to the minor axis length is a threshold or more. Thus, in the range imaging device 1 according to the first embodiment, the power of light applied using the dot light Dt can be locally increased, and the area where no light is applied in the object OB can be reduced. Accordingly, the resolution of the range image captured using a dot light source can be prevented from being reduced.

In the range imaging device 1 according to the first embodiment, of the multiple patterns of dot light Dt, at least part of at least one pattern of dot light Dt1 (first dot light pattern) is overlapped with at least part of another pattern of dot light Dt2 adjacent to the pattern of dot light Dt1 in the major axis direction. Thus, in the range imaging device 1 according to the first embodiment, the area where no light is applied in the object OB can be further reduced.

In the range imaging device 1 according to the first embodiment, the light source unit 2 includes light source elements each of which can independently emit the light pulses PO. Thus, in the range imaging device 1 according to the first embodiment, each of the light source elements can emit dot light with elliptical patterns, thereby increasing flexibility for setting the position or orientation of the dot light to be emitted.

In the range imaging device 1 according to the first embodiment, the elliptical patterns of dot light emitted from one of at least two of the light source elements have a major axis direction different from the major axis direction of the elliptical patterns of dot light emitted from the other thereof. Thus, in the range imaging device 1 according to the first embodiment, lines of light L intersecting each other can be used for the object OB to irradiate the object OB with light in a mesh pattern to comprehensively reduce the area where no light is applied in the object OB.

In the range imaging device 1 according to the first embodiment, the elliptical patterns of dot light emitted from one of at least two of the light source elements have a major axis direction perpendicular to the major axis direction of the elliptical patterns of dot light emitted from the other thereof. Thus, in the range imaging device 1 according to the first embodiment, the object OB can be irradiated with light in a lattice pattern to achieve an effect similar to the effect described above.

In the range imaging device 1 according to the first embodiment, the intervals K1 and K2 are different from each other. The interval K1 is an interval from the line of light L101 to the line of light L102, and is an example of the first interval. The interval K2 is an interval from the line of light L103 to the line of light L104, and is an example of the second interval. Thus, in the range imaging device 1 according to the first embodiment, measurement can be performed with different resolution between the horizontal and vertical directions. For example, if an object OB moving in the horizontal direction is the target of measurement, the distance changing with the movement in the horizontal direction can be measured with high resolution.

In the range imaging device 1 according to the first embodiment, the elliptical patterns of dot light with the same major axis direction emitted from at least three of the light source elements have intervals different in the minor axis direction. Thus, in the range imaging device 1 according to the first embodiment, measurement can be performed with resolution suitable for the region where the object is present. For example, when an object OB with a small height is targeted for measurement, the upper region where the object OB is not present can be measured with low resolution and the center to lower region where the object OB is present can be measured with high resolution.

In the range imaging device 1 according to the first embodiment, the elliptical patterns of dot light emitted from at least two light source elements among the light source elements have major axis directions which are oblique, instead of perpendicular or parallel, relative to the surface on which the imaging device is installed. Thus, in the range imaging device 1 according to the first embodiment, such lines of light can be achieved by mounting two diffusers with the top and bottom reversed between the two diffusers for emitting lines of light L in the oblique directions, thereby reducing device cost, compared to the case of separately using diffusers for the vertical and horizontal directions.

In the range imaging device 1 according to the first embodiment, the elliptical patterns of dot light emitted from at least two light source elements among the light source elements have major axis directions at an angle of 45 degrees or 135 degrees relative to the surface on which the imaging device is installed. Thus, in the range imaging device 1 according to the first embodiment, lines of light can be emitted in the oblique directions relative to the ground in a bilaterally symmetrical manner to thereby achieve an effect similar to the effect described above.

In the range imaging device 1 according to the first embodiment, at least one of the light source elements is a diffusion light source. Thus, in the range imaging device 1 according to the first embodiment, the dot light and the diffuse light source can be appropriately used depending on the measurement conditions according to the distance to the object OB, and deterioration in resolution can be suppressed in both of the short and long distance cases.

In the range imaging device 1 according to the first embodiment described above, all or part of the range image processing unit 4 may be realized by a computer. In that case, the range image processing unit 4 may be achieved by recording programs for realizing the functions on a computer readable recording medium and allowing a computer system to read and execute the programs recorded on the recording medium. The computer system referred to herein includes an operating system (OS) and hardware components such as peripheral devices. The computer readable recording medium refers to a storage device such as a portable medium, e.g., a flexible disk, magneto-optical disk, ROM, CD-ROM, etc., or a hard disk incorporated in the computer system. The computer readable recording medium may include a medium dynamically retaining programs for a short period of time, such as a communication line that transmits programs through a network such as the Internet or a telecommunication line such as a telephone line, or a medium retaining the programs for a given period of time in that case, such as a volatile memory of the computer system serving as a server or a client. The above programs may realize part of the functions described above, or may realize the functions in combination with programs already recorded in the computer system, or may realize the functions using a programmable logic device, such as an FPGA.

Some embodiments of the present invention have been described in detail so far referring to the drawings. However, the specific configurations are not limited to these embodiments but may include designs within the scope not departing from the spirit of the present invention.

### Second Embodiment

Referring to the drawings, a range imaging device and a range imaging method according to a second embodiment of the present invention will be described below.

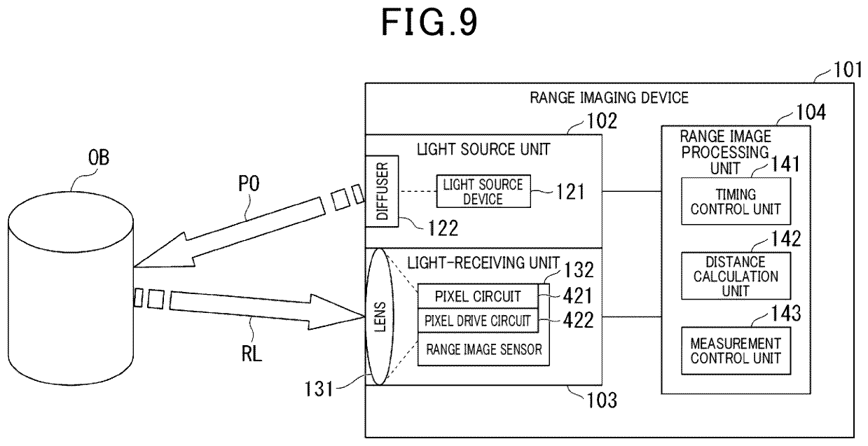

FIG. 9 is a block diagram illustrating an example of a range imaging device 101 according to the second embodiment. As shown in FIG. 9, the range imaging device 101 includes a light source unit 102, a light-receiving unit 103, and a range image processing unit 104. FIG. 9 also illustrates an object OB the distance to which is measured by the range imaging device 101. A range imaging element may be, for example, a range imaging sensor 132 (described later) in the light-receiving unit 103.

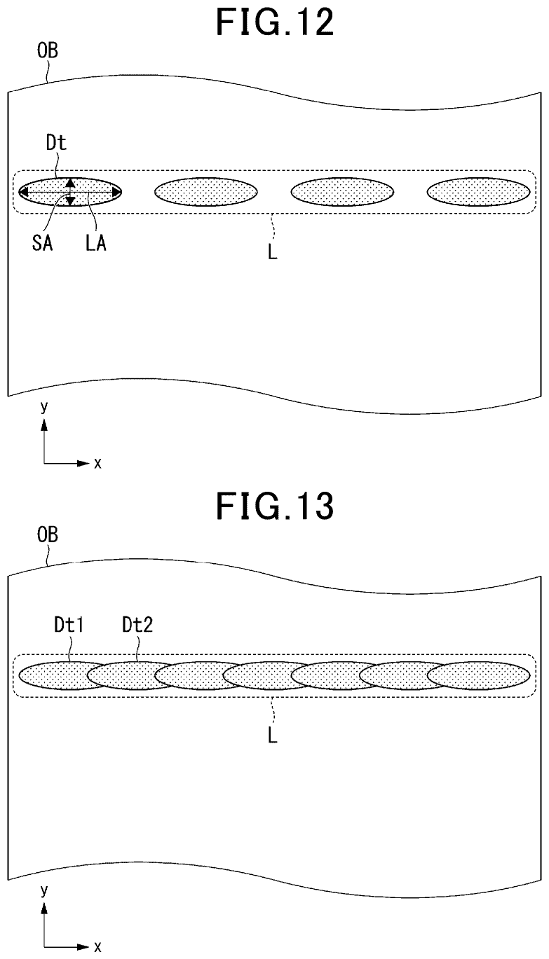

The light source unit 102 emits light pulses PO to the object OB. The light source unit 102 emits light pulses PO into a space as a measurement target where the object OB is present whose distance is to be measured by the range imaging device 101 under the control of the range image processing unit 104. The light source unit 102 may be, for example, a surface-emitting semiconductor laser module such as a vertical-cavity surface-mitting laser (VCSEL). The light source unit 102 emits light pulses PO including structured light composed of periodically formed lines of light L (see FIGS. 12 to 14), i.e., light pulses PO in which lines of light L in two directions are perpendicular to each other. Details of the lines of light L will be described later referring to FIGS. 12 to 14. The light source unit 102 includes a light source device 121 and a diffuser 122.

The light source device 121 is a light source that emits laser light in the near infrared wavelength band (e.g., wavelength band of 850 nm to 940 nm) which serves as the light pulses PO to be applied to the object OB. The light source device 121 may be, for example, a semiconductor laser light emitting device. The light source device 121 emits pulsed laser light in response to the control of a measurement control unit 143.

The diffuser 122 is an optical component which diffuses laser light in the near infrared wavelength band emitted from the light source device 121 over the emission surface area of the object OB. Pulsed laser light diffused by the diffuser 122 is emitted as the light pulses PO and applied to the object OB.

The light-receiving unit 103 receives reflected light RL arising from reflection of the light pulses PO from the object OB, which is the object whose distance is to be measured by the range imaging device 101, and outputs a pixel signal according to the received reflected light RL. The light-receiving unit 103 includes a lens 131 and a range imaging sensor 132.

The lens 131 is an optical lens that guides the incident reflected light RL to the range imaging sensor 132. The lens 131 outputs the incident reflected light RL toward the range imaging sensor 132, so that the light can be received by (be incident on) pixel circuits 421 provided to the light-receiving area of the range imaging sensor 132.

The range imaging element sensor 132 is an imaging element used for the range imaging device 101. The range imaging sensor 132 includes pixel circuits 421 formed in a two-dimensional light-receiving area, and a pixel drive circuit 422 that controls the pixel circuits 421.

The pixel circuits 421 each include one photoelectric conversion element (e.g., photoelectric conversion element PD described later), charge storage units (e.g., charge storage units CS (CS1 to CS4) described later) corresponding to this photoelectric conversion element, and components for distributing charge to the individual charge storage units.

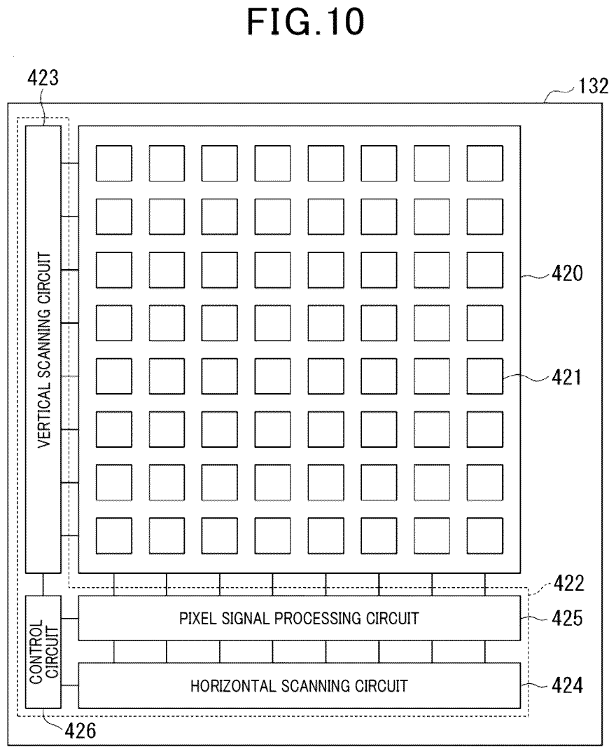

The pixel drive circuit 422 causes transfer transistors G (described later) to be electrically connected to the respective charge storage units CS (CS1 to CS4) at a predetermined integration timing synchronized with emission of the optical pulse PO for distribution and integration of charge. Details of the range imaging sensor 132 including the pixel circuits 421 and the pixel drive circuit 422 will be described below referring to FIG. 10.

In response to the control of the measurement control unit 143, the range imaging sensor 132 distributes charge, which has been generated by the photoelectric conversion element, to the charge storage units. Also, the range imaging sensor 132 outputs pixel signals according to the amount of charge distributed to the charge storage units. The range imaging sensor 132, in which pixel circuits are formed in a two-dimensional matrix, outputs single-frame pixel signals corresponding to the respective pixel circuits.

Referring to FIG. 10, the detailed configuration of the range imaging sensor 132 will be described. FIG. 10 is a block diagram illustrating an example of the range imaging sensor, according to the present embodiment.

As shown in FIG. 10, the range imaging sensor 132 includes, for example, a light-receiving area 420 where the pixel circuits 421 are formed, and the pixel drive circuit 422. The pixel drive circuit 422 includes a vertical scanning circuit 423 performing a distribution operation, a horizontal scanning circuit 424, a pixel signal processing circuit 425, and a control circuit 426.

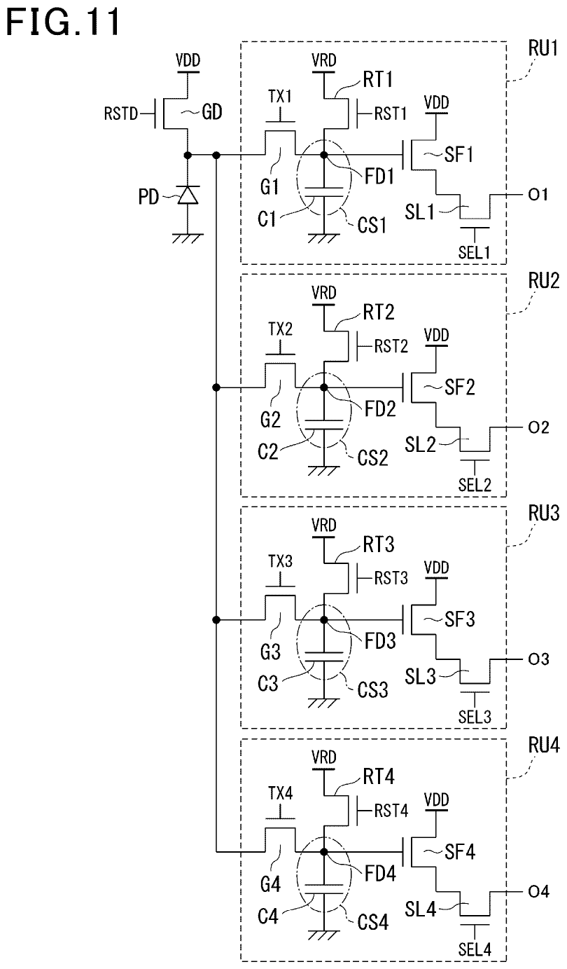

The light-receiving area 420 is an area where the pixel circuits 421 are formed. FIG. 10 illustrates an example in which the pixel circuits 421 are formed in a two-dimensional matrix of 8 rows and 8 columns. The pixel circuits 421, which are formed in a two-dimensional matrix, integrate charge corresponding the intensity of received light. The detailed configuration of the pixel circuits 421 will be described later referring to FIG. 11.

The control circuit 426 performs overall control of the range imaging sensor 132. The control circuit 426 controls, for example, the operation of the components of the range imaging sensor 132 according to the instructions from the measurement control unit 143 of the range image processing unit 104. The components of the range imaging sensor 132 may be directly controlled by the measurement control unit 143. In this case, the control circuit 426 can be omitted.

The vertical scanning circuit 423 is a circuit that controls the pixel circuits 421 formed in the light-receiving area 420 row by row in response to the control of the control circuit 426. The vertical scanning circuit 423 causes the pixel signal processing circuit 425 to output a voltage signal corresponding to the amount of charge integrated in charge storage units CS of each pixel circuit 421. In this case, the vertical scanning circuit 423 distributes charge converted by the photoelectric conversion element to the charge storage units of each pixel circuit 421 for integration therein.

The pixel signal processing circuit 425 is a circuit that performs predetermined signal processing (e.g., noise suppression processing and A/D conversion processing) on voltage signals outputted from the pixel circuits 421 of each column in response to the control of the control circuit 426.

The horizontal scanning circuit 424 is a circuit that sequentially outputs the signals outputted from the pixel signal processing circuit 425 in chronological order in response to the control of the control circuit 426. Thus, the pixel signals corresponding to the amount of charge integrated for a single frame are sequentially outputted to the range image processor 104. The following description is provided assuming that the pixel signal processing circuit 425 performs A/D conversion processing and the pixel signals are digital signals.

Referring now to FIG. 11, the configuration of the pixel circuits 421 formed in the light-receiving area 420 of the range imaging sensor 132 will be described. FIG. 11 is a block diagram illustrating an example of a pixel circuit 421 according to the present embodiment. The pixel circuit 421 shown in FIG. 11 is a configuration example including four pixel signal readouts RU (RU1 to RU4).

As shown in FIG. 11, the pixel circuit 421 includes one photoelectric conversion element PD, a charge discharge transistor (drain gate transistor) GD (charge discharge unit, charge discharge section), and four pixel signal readouts RU (RU1 to RU4) which output voltage signals from respective output terminals O (O1 to O4). Each of the pixel signal readouts RU includes a transfer transistor G, a floating diffusion FD, a charge storage capacitor C, a reset transistor RT, a source follower transistor SF, and a selection transistor SL. The floating diffusion FD and the charge storage capacitor C configure a charge storage unit CS.

In the pixel circuit 421 shown in FIG. 11, the pixel signal readout RU1 that outputs a voltage signal from the output terminal O1 includes a transfer transistor G1, a floating diffusion FD1, a charge storage capacitor C1, a reset transistor RT1, a source follower transistor SF1, and a selection transistor SL1. In the pixel signal readout RU1, the floating diffusion FD1 and the charge storage capacitor C1 constitute a charge storage unit CS1. The pixel signal readout units RU2 to RU4 also have the same configuration.

The photoelectric conversion element PD is an embedded photodiode which performs photoelectric conversion of incident light, generates charge corresponding to the incident light, and integrates the generated charge. In the present embodiment, incident light is incident from a space targeted for measurement.

In the pixel circuit 421, charge generated by photoelectric conversion of incident light by the photoelectric conversion element PD is distributed to the four charge storage units CS (CS1 to CS4), and voltage signals corresponding to the amount of the distributed charge are outputted to the pixel signal processing circuit 425.

The configuration of each pixel circuit formed in the range imaging sensor 132 is not limited to the configuration, as shown in FIG. 11, provided with the four pixel signal readouts RU (RU1 to RU4), but the pixel circuit may be constituted to include one or more pixel signal readouts RU.

In response to the pixel circuits 421 being driven, the light pulses PO are emitted at an emission time To and the reflected light RL is received by the range imaging sensor 132 after a delay Td. Under the control of the measurement control unit 143, the pixel drive circuit 422 supplies integration drive signals TX1 to TX4 to the transfer transistors G (G1, G2, G3 and G4), being synchronized with emission of the light pulses PO according to the frame cycle to distribute charge generated in the photoelectric conversion element PD for sequential integration in the charge storage units CS1, CS2, CS3 and CS4.

The pixel drive circuit 422 controls the reset transistors RT and the selection transistors SL using respective drive signals RST and SEL, converts the charge integrated in the charge storage units CS into electrical signals using the source follower transistors SF, and outputs the converted electrical signals to the distance calculation unit 142 via the output terminals O.

Under the control of the measurement control unit 143, the pixel drive circuit 422 passes and discharges the charge generated in the photoelectric conversion element PD to power sources VDD using a drive signal RSTD (eliminates the charge).

Referring back to FIG. 9, the range image processor 104 controls the range imaging device 101 and calculates the distance to the object OB. The range image processing unit 104 measures a distance, as a measurement distance, to the object OB present in the measurement space based on the amount of charge integrated in the charge storage units CS. The range image processing unit 104 includes a timing control unit 141, the distance calculation unit 142, and the measurement control unit 143.

The timing control unit 141 controls timing of outputting various control signals required for measurement, in response to the control of the measurement control unit 143. The various control signals include, for example, a signal for controlling emission of the light pulses PO, a signal for distributing the reflected light RL to the charge storage units for integration therein, a signal for controlling the number of integrations per frame, and other signals. The number of integrations refers to the number of repetitions of the processing for distributing charge to the charge storage units CS for integration therein, i.e., the number of distributions preset in a frame cycle. The product of the number of integrations and the duration (duration for integration) for integrating charge in the charge storage units in each charge distribution and integration processing is an exposure time.

The distance calculation unit 142 outputs distance information indicating the distance to the object OB calculated based on the pixel signals outputted from the range imaging sensor 132. The distance calculation unit 142 calculates a delay Td from when the light pulses PO are emitted until when the reflected light RL is received, based on the amount of charge integrated in the charge storage units CS. The distance calculation unit 142 calculates the distance to the object OB according to the calculated delay.

In the present embodiment, the frame cycle includes subframe cycles with different integration periods for integrating charge in the charge storage units CS. The distance calculation unit 142 calculates the distance to the object OB using a subframe cycle, among the subframe cycles, in which the amount of charge does not exceed a preset threshold (the amount of charge is not saturated). Details of the frame cycle and the subframe cycles will be described later.

Using the fact that the amount of charge corresponding to the reflected light RL component is distributed to and integrated in two charge storage units CS at a ratio according to the delay Td before the reflected light RL is incident on the range imaging device 101, the distance calculation unit 142 calculates a delay Td using the following Formula (2). The distance calculation unit 142 multiplies the delay Td calculated through Formula (2) by the speed of light (velocity) to calculate a round-trip distance to the object OB. The distance calculation unit 142 calculates the distance to the object OB by halving the round-trip distance calculated above. Formula (2) assumes that the amount of charge corresponding to the external light component is integrated in the charge storage unit CS1 and the amount of charge corresponding to the reflected light RL component is distributed to and integrated in the charge storage units CS2 and CS3.

Td=To×(Q3−Q1)/(Q2+Q3−2×Q1) (2)

In the formula, To represents a period during which the light pulses PO are emitted, Q1 represents the charge integrated in the charge storage unit CS1, Q2 represents the charge integrated in the charge storage unit CS2, and Q3 represents the charge integrated in the charge storage unit CS3.

The measurement control unit 143 controls the timing control unit 141. For example, the measurement control unit 143 may set the number of integrations and duration for integration in a single frame and may control the timing control unit 141 so that an image is captured according to the settings. In other words, the measurement control unit 143 may set a frame cycle including subframe cycles and may control the timing control unit 141 so that an image is captured according to the settings.

With this configuration, in the range imaging device 101, the light source unit 102 emits the light pulses PO in the near infrared wavelength band toward the object OB, the light-receiving unit 103 receives the reflected light RL arising from the reflection of the light pulses PO from the object OB, and the range image processing unit 104 outputs distance information (range image) indicating the distance to the object OB as measured.

Referring to the drawings, an operation of the range imaging device 101 according to the present embodiment will be described. Referring to FIGS. 12 to 14, first, the line of light L outputted from the light source unit 102 according to the present embodiment will be described. In the following description referring to FIGS. 12 to 14, the X-axis direction is referred to as horizontal-axis direction (horizontal direction) and the Y-axis direction is referred to as vertical-axis direction (vertical direction).

In the present embodiment, dot light is used as light emitted from the light source unit 102. For example, dot light may include structured light composed of periodically formed as patterns of dot light.

Using dot light, non-uniform local light pulses PO are applied to the object OB. Using dot light, the power of emitted light (emission intensity per unit area) can be increased without increasing the light source output, and the reach of the emitted light can be increased to thereby increase the measurable distance. However, using dot light, distance cannot be measured for the area where the dot light is not applied, which raises an issue of low resolution.

To address this issue, in the present embodiment, patterns of dot light each having an elliptical shape are used as the light pulses PO. For example, the light source unit 102 may include light source elements each of which can independently emit the light pulses PO (line of light using patterns of dot light each having an elliptical shape).

FIGS. 12 to 14 show examples of the line(s) of light L according to the present embodiment. FIGS. 12 to 14 each schematically illustrate a state in which line(s) of light L as the light pulses PO has been applied to the object OB by the range imaging device 101.

FIG. 12 shows an example in which patterns of dot light Dt are discretely emitted to form a line of light L. In the example shown, a line of light L is emitted in the horizontal direction. As shown in FIG. 12, the line of light L is formed by discretely emitting patterns of dot light Dt in a line. Herein, each pattern of dot light Dt has an elliptical shape in which the ratio of a major axis length LA to a minor axis length SA is a threshold or more. For example, each pattern of a dot light source may have an elliptical shape in which the ratio of the major axis length LA to the minor axis length SA is 2 or greater.

Thus, in the present embodiment, use of elliptical patterns of dot light Dt can reduce the area in the object OB where no light is applied, compared to the case where circular patterns of dot light Dt are used. Accordingly, deterioration in resolution can be suppressed.

FIG. 13 shows an example in which a line of light L is formed by emitting patterns of dot light Dt overlapped with each other. In the example shown, a line of light L is emitted in the horizontal direction. As shown in FIG. 13, the line of light L is formed by allowing part of a pattern of dot light Dt to overlap with part of another pattern of dot light Dt. In this way, in the present embodiment, a continuous line of light L can be formed by applying light such that at least part of a pattern of dot light Dt1 overlaps with at least part of another pattern of dot light Dt2 adjacent to the pattern of dot light Dt1 in the major axis direction. Such a line of light may be used instead of or together with the dot light source of the present embodiment.

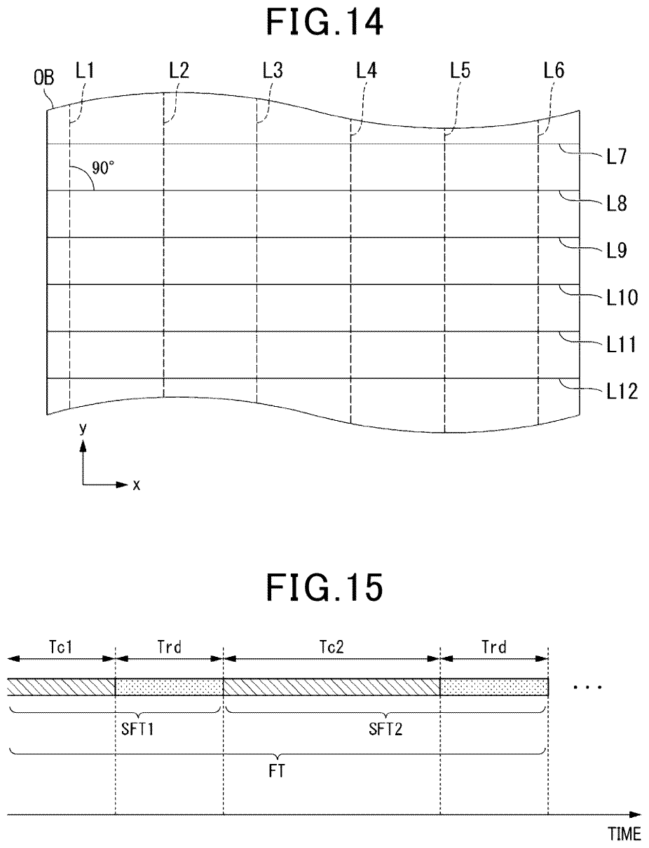

FIG. 14 shows a state in which lines of light L are intersected with each other. Thus, in the present embodiment, the light source unit 102 emits light pulses to the object OB such that lines of light L are differently directed. In this case, the elliptical patterns of dot light Dt may be formed to have different major axis directions. Thus, light can be emitted in a mesh pattern to the object OB, and the area where no light is applied in the object OB can be further reduced.

FIG. 14 shows an example in which the direction of a group of lines of light L1 to L6 (vertical lines of light) is perpendicular to, i.e., makes a 90-degree angle with, the direction of a group of lines of light L7 to L12 (vertical lines of light). Thus, the elliptical patterns of dot light Dt emitted from one of at least two of the light source elements have a major axis direction perpendicular to the other thereof.

The angle between the two lines of light L is not limited to 90 degrees, but the directions of at least two lines of light L may only need to be different from each other. In other words, the angle between the two lines of light L may only need to be greater than 0 degrees and less than or equal to 90 degrees.

Thus, in the present embodiment, the light source unit 102 emits light pulses PO including structured light composed of periodically formed lines of light L, i.e., light pulses PO in which lines of light L in two directions are perpendicular to each other.

Referring back to FIGS. 9 to 11, a basic distance measurement operation of the range imaging device 101 will be described.

In response to the pixel circuits 421 of the range imaging device 101 being driven, the light pulses PO are emitted at an emission time To and the reflected light RL is received by the range imaging sensor 132 after a delay Td. In synchronization with emission of the light pulses PO, the vertical scanning circuit 423 distributes charge generated in the photoelectric conversion element PD to the charge storage units CS1, CS2, CS3 and CS4 in this order for integration therein.

In this case, the vertical scanning circuit 423 turns on (electrically connects) the transfer transistor G1 provided on the transfer path through which charge is transferred to the charge storage unit CS1 from the photoelectric conversion element PD. Thus, the charge photoelectrically converted by the photoelectric conversion element PD is integrated in the charge storage unit CS1 via the transfer transistor G1. After that, the vertical scanning circuit 423 turns off (electrically disconnects) the transfer transistor G1. Thus, charge transfer to the charge storage unit CS1 is stopped. In this way, the vertical scanning circuit 423 causes the charge storage unit CS1 to integrate charge therein. The same applies to other charge storage units CS2 to CS4.

In this case, in a charge integration period in which charge is distributed to the charge storage units CS, the integration cycle is repeated in which the integration drive signals TX1 to TX4 are supplied to the respective transfer transistors G1 to G4.

Thus, charge corresponding to the incident light is transferred to the charge storage units CS1 to CS4 from the photoelectric conversion element PD via the respective transfer transistors G1 to G4. The integration cycle is repeated multiple times in the charge integration period. Thus, charge is integrated in the charge storage units CS1 to CS4 every integration cycle of each of the charge storage units CS1 to CS4 during the charge integration period.

When repeating the integration cycle for each of the charge storage units CS1 to CS4, after completing charge transfer (distribution) to the charge storage unit CS4, the vertical scanning circuit 423 turns on the charge discharge transistor GD provided on the discharge path through which charge is discharged from the photoelectric conversion element PD.

Thus, before restarting the integration cycle for the charge storage unit CS1, the charge discharge transistor GD discards the charge generated in the photoelectric conversion element PD after completing the previous integration cycle for the charge storage unit CS4 (i.e., resets the photoelectric conversion element PD).

The vertical scanning circuit 423 causes all the pixel circuits 421 formed in the light-receiving area 420 to sequentially output a voltage signal to the pixel signal processing circuit 425, for each row (the array in the horizontal direction) of the pixel circuits 421.

The pixel signal processing circuit 425 performs signal processing such as A/D conversion processing for each of the inputted voltage signals, and outputs the processed signal to the horizontal scanning circuit 424. The horizontal scanning circuit 424 sequentially outputs the processed voltage signals to the distance calculation unit 142 in the order of the columns in the light-receiving area 420.

As described above, the vertical scanning circuit 423 repeatedly integrates charge in the charge storage units CS and discards the charge photoelectrically converted by the photoelectric conversion element PD in a single frame. Thus, charge corresponding to the intensity of light received by the range imaging device 101 in a predetermined time interval is integrated in the individual charge storage units CS. The horizontal scanning circuit 424 outputs the electrical signals corresponding to the amount of single-frame charge integrated in the charge storage units CS to the distance calculation unit 142.

In the present embodiment, a frame cycle FT includes subframe cycles SFT. Herein, referring to FIG. 15, the frame cycle FT and the subframe cycles SFT according to the present embodiment will be described.

FIG. 15 is a diagram illustrating an example of the frame cycle FT according to the present embodiment.

As shown in FIG. 15, the frame cycle FT according to the present embodiment includes two subframe cycles SFT, i.e., a subframe cycle SFT1 and a subframe cycle SFT2. In both of the subframe cycles SFT1 and SFT2, the object OB is simultaneously irradiated with vertical lines of light and horizontal lines of light perpendicular to each other, as shown in FIG. 14.

The subframe cycle SFT1 (first subframe cycle) includes an integration period Tc1 in which charge is integrated in the charge storage units CS (charge integration period) and a readout period Trd in which the charge integrated in the charge storage units CS is read out. For example, the integration period Tc1 may be a predetermined period which is preset so that the charge in the charge storage units CS is not saturated (does not exceed a preset threshold) at the intersections of the lines of light L described above. The integration period Tc1 is ½ of an integration period Tc2 of the subframe cycle SFT2. The integration period Tc1 (charge integration period) is determined according to the number of integrations.

The subframe cycle SFT2 (second subframe cycle) includes an integration period Tc2 in which charge is integrated in the charge storage units CS (charge integration period) and a readout period Trd in which the charge integrated in the charge storage units CS is read out. The subframe cycle SFT2 is a subframe cycle SFT different in integration period from the subframe cycle SFT1. For example, the integration period Tc2 may be a period which is preset so that the range image can be appropriately measured in portions other than the intersections of the lines of light L mentioned above. The integration period Tc2 is equal to or greater than twice the integration period Tc1 of the subframe cycle SFT1. The integration period Tc2 is determined, similarly to the integration period Tc1, according to the number of integrations.

The distance calculation unit 142 calculates the distance to the object OB using a subframe cycle SFT, among the subframe cycles SFT1 and SFT2, in which the amount of charge has not exceeded the preset threshold.

The distance calculation unit 142 calculates the distance to the object OB using the subframe cycle SFT2 if, for example, the amount of charge has not exceeded the preset threshold in the subframe cycle SFT2. If the amount of charge has exceeded the preset threshold, the distance calculation unit 142 calculates the distance to the object OB using the subframe cycle SFT1 in which the integration period Tc is shorter than in the subframe cycle SFT2.

Specifically, for example, the distance calculation unit 142 may calculate the distance to the object OB using a subframe cycle SFT, among the subframe cycles SFT1 and SFT2, in which the amount of charge has not exceeded the threshold and the integration period is longer. When calculating the distance to the object OB, the distance calculation unit 142 uses the above Formula (2).

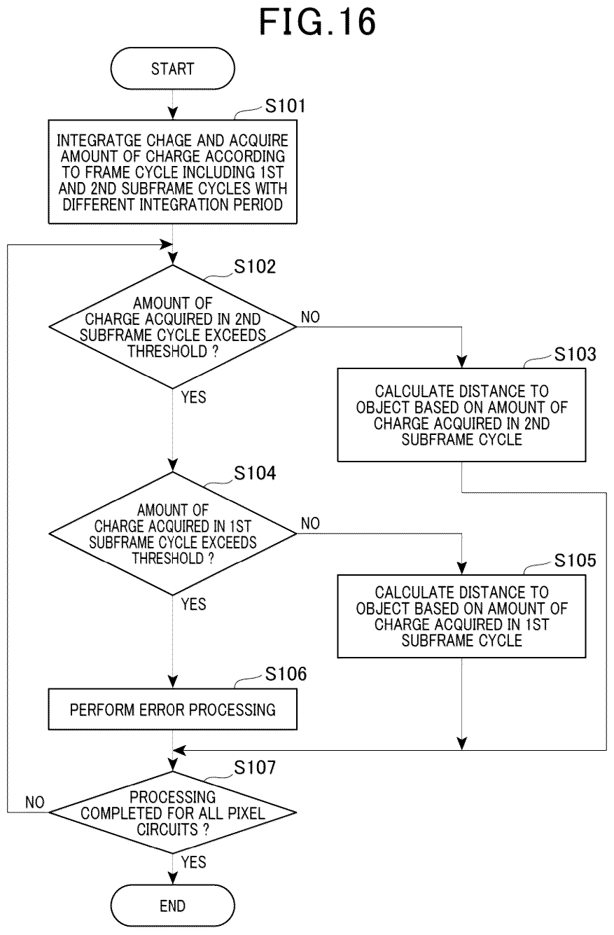

Next, referring to FIG. 16, a description will be given of the details of the calculation processing for the distance to the object OB performed by the range imaging device 101 according to the present embodiment. FIG. 16 is a flow chart illustrating an example of an operation of the range imaging device 101 according to the present embodiment. Herein, an example of calculation processing for the distance to the object OB will be described.

As shown in FIG. 16, the range imaging device 101 integrates charge and acquires the amount of charge, first, according to the frame cycle FT including the first subframe cycle (subframe cycle SFT1) and the second subframe cycle (subframe cycle SFT2) whose integration periods Tc are different from each other (S101). The measurement control unit 143 of the range imaging device 101 instructs the timing control unit 141 to integrate charge and acquire the amount of charge according to the frame cycle FT. In response to the control of the measurement control unit 143, the timing control unit 141 integrates charge and acquires the amount of charge according to the frame cycle FT including the subframe cycles SFT1 and SFT2.

Next, the measurement control unit 143 of the range imaging device 101 determines whether the amount of charge acquired in the second subframe cycle (subframe cycle SFT2) has exceeded the threshold (S102). If the amount of charge acquired in the subframe cycle SFT2 has exceeded the threshold (YES at S102), the measurement control unit 143 allows processing to proceed to S104. If the amount of charge acquired in the subframe cycle SFT2 has not exceeded the threshold (NO at S102), the measurement control unit 143 allows processing to proceed to S103.

At S103, the measurement control unit 143 instructs the distance calculation unit 142 to perform distance calculation processing and, in response, the distance calculation unit 142 calculates the distance to the object OB based on the amount of charge acquired in the second subframe cycle (subframe cycle SFT2). For example, the distance calculation unit 142 may calculate the distance to the object OB using Formula (2) and the amount of charge acquired in the subframe cycle SFT2. Herein, the distance calculation unit 142 calculates the distance to a portion other than the intersections of the lines of light L, using the amount of charge acquired in the subframe cycle SFT2. Following the processing at S103, the distance calculation unit 142 allows processing to proceed to S107.

At S104, the measurement control unit 143 determines whether the amount of charge acquired in the first subframe cycle (subframe cycle SFT1) has exceeded the threshold. If the amount of charge acquired in the subframe cycle SFT1 has exceeded the threshold (YES at S104), the measurement control unit 143 allows processing to proceed to S106. If the amount of charge acquired in the subframe cycle SFT1 has not exceeded the threshold (NO at S104), the measurement control unit 143 allows processing to proceed to S105.

At S105, the measurement control unit 143 instructs the distance calculation unit 142 to perform distance calculation processing and, in response, the distance calculation unit 142 calculates the distance to the object OB based on the amount of charge acquired in the first subframe cycle (subframe cycle SFT1). For example, the distance calculation unit 142 may calculate the distance to the object OB using Formula (2) and the amount of charge acquired in the subframe cycle SFT1. Herein, the distance calculation unit 142 calculates the distance for the intersection portions of the lines of light L, using the amount of charge acquired in the subframe cycle SFT1. Following the processing at S105, the distance calculation unit 142 allows processing to proceed to S107.

At S106, the measurement control unit 143 performs error processing. Since this case corresponds to the case where the amount of charge acquired in the first subframe cycle has exceeded the threshold (has saturated), the measurement control unit 143 may perform, for example, re-measurement processing or error processing such as warning output.

Next, at S107, the measurement control unit 143 determines whether the processing for all the pixel circuits 421 has been completed. In other words, the measurement control unit 143 determines whether the distance calculation processing corresponding to a single-frame cycle FT has been completed. If the processing for all the pixel circuits 421 has been completed (YES at S107), the measurement control unit 143 terminates the processing. If the processing for all the pixel circuits 421 has not been completed (NO at S107), the measurement control unit 143 allows processing to return to S102 to perform distance calculation processing for the subsequent pixel circuit 421.

In this way, in the range imaging device 101 according to the present embodiment, the distance calculation unit 142 calculates the distance to the object OB using a subframe cycle SFT, among the subframe cycles SFT1 and SFT2, in which the amount of charge has not exceeded the threshold and the integration period is longer.

As described above, the range imaging device 101 according to the present embodiment includes the light source unit 102, the light-receiving unit 103, and the distance calculation unit 142. The light source unit 102 emits light pulses PO to the object OB. The light-receiving unit 103 includes the pixel circuits 421, the pixel drive circuit 422, and the charge discharge transistor GD (charge discharge section). The pixel circuits 421 formed in a two-dimensional matrix each includes the photoelectric conversion element PD generating charge corresponding to incident light and charge storage units CS integrating the charge. The pixel drive circuit 422 distributes charge to the charge storage units CS for integration therein at the integration timing synchronized with the emission of the light pulses PO according to the frame cycle FT. The charge discharge transistor GD (charge discharge section) discharges charge in the period other than the integration timing. The distance calculation unit 142 calculates the distance to the object OB based on the amount of charge integrated in the charge storage units CS. The light source unit 102 emits the light pulses PO including structured light composed of periodically formed lines of light L, i.e., the light pulses PO in which lines of light L in two directions are perpendicular to each other. The frame cycle FT includes subframe cycles SFT with different integration periods for integrating charge in the charge storage units CS. The distance calculation unit 142 calculates the distance to the object OB using a subframe cycle SFT in which the amount of charge has not exceeded the preset threshold, among the subframe cycles SFT.

The range imaging device 101 of the present embodiment calculates the distance to the object OB using a subframe cycle SFT in which the amount of charge has not exceeded the preset threshold, among the subframe cycles SFT with different integration periods. Therefore, the range imaging device 101 of the present embodiment can calculate the distance to the object OB using, for example, a subframe cycle SFT in which the charge storage units CS have not been saturated at the intersections of the lines of light L. Accordingly, the range imaging device 101 of the present embodiment can mitigate the signal output difference between the intersections of the lines of light L and portions other than the intersections to suppress deterioration in resolution for the entire range image and reduction in measurable distance. The range imaging device 101 of the present embodiment can suppress deterioration in resolution, while suppressing required light source output, by using the lines of light L.

In the present embodiment, the subframe cycles SFT include the subframe cycle SFT1 (first subframe cycle) in which the integration period is a predetermined period set in advance (e.g., integration period Tc1), and the subframe cycle SFT2 (second subframe cycle) in which the integration period is equal to or greater than twice the integration period of the predetermined period (e.g., integration period Tc2). The distance calculation section 142 calculates the distance to the object OB using a subframe cycle SFT, among the subframe cycles SFT1 and SFT2, in which the amount of charge has not exceeded the threshold and the integration period is longer.

Thus, in the range imaging device 101 of the present embodiment, the distance to the object OB is calculated using the subframe cycle SFT1 (first subframe cycle) for the intersections of the lines of light L, and the distance to the object OB is calculated using the subframe cycle SFT2 (second subframe cycle) for portions other than the intersections. Accordingly, the range imaging device 101 of the present embodiment can suppress saturation of charge at the intersections of the lines of light L, while maintaining resolution at portions other than the intersections of the lines of light L, so that the distance to the object OB can be measured with high accuracy for the intersections of the lines of light L.

In the present embodiment, the light source unit 102 includes light source elements each of which can independently emit the light pulses PO. Each line of light L is formed by discretely emitting patterns of dot light Dt in a line from the light source elements, or by emitting patterns of dot light Dt in a line so as to overlap with each other (e.g., see FIG. 12). Thus, the range imaging device 101 of the present embodiment can suppress deterioration in resolution by using the lines of light L.

In the present embodiment, the patterns of dot light Dt each have an elliptical shape in which the ratio of the major axis length to the minor axis length is 2 or greater, and a line of light L is formed in a line along the major axis direction. Thus, in the range imaging device 101 of the present embodiment, use of elliptical patterns of dot light Dt can reduce the area in the object OB where no light is applied, compared to the case where circular patterns of dot light Dt are used, and therefore, deterioration in resolution can be further suppressed.

The range imaging method of the present embodiment is a method for the range imaging device 101 including the light source unit 102, light-receiving unit 103, and distance calculation unit 142 described above. In the range imaging method, the light source unit 102 emits the light pulses PO including structured light composed of periodically formed lines of light L, i.e., the light pulses PO in which lines of light L in two directions are perpendicular to each other. The frame cycle FT includes subframe cycles SFT with different integration periods for integrating charge in the charge storage units CS. The distance calculation unit 142 calculates the distance to the object OB using a subframe cycle SFT in which the amount of charge has not exceeded the preset threshold, among the subframe cycles SFT.

Thus, the range imaging method of the present embodiment can achieve effects as in the range imaging device 101 described above, i.e., can mitigate the signal output difference between the intersections of the lines of light L and portions other than the intersections to suppress deterioration in resolution of the entire range image and reduction in measurable distance.

### Third Embodiment

Referring to the drawings, a range imaging device 101a according to a third embodiment will be described. In the third embodiment, a modification will be described in which measurement is performed by alternately using the light pulses PO with vertical lines of light L and the light pulses PO with horizontal lines of light L in subframe cycles to calculate the distance to the object OB.

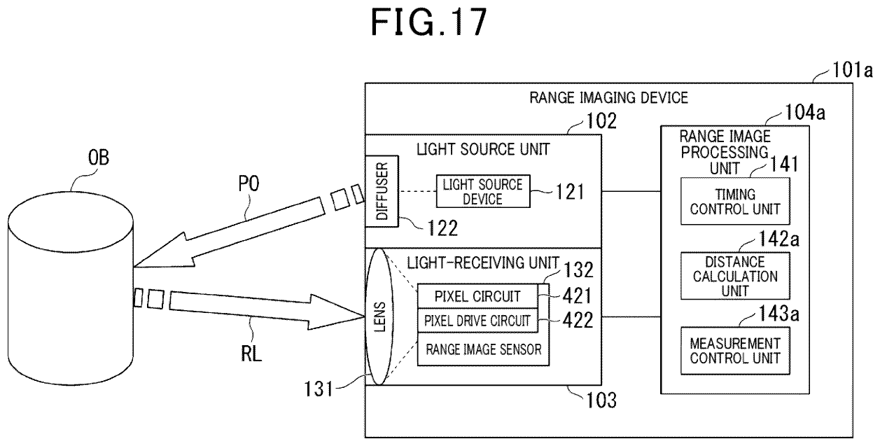

FIG. 17 is a block diagram illustrating an example of the range imaging device 101a according to the third embodiment. As shown in FIG. 17, the range imaging device 101a includes a light source unit 102, a light-receiving unit 103, and a range image processing unit 104a. FIG. 17 also illustrates an object OB the distance to which is measured by the range imaging device 101a. A range imaging element may be, for example, a range imaging sensor 132 in the light-receiving unit 103.

In FIG. 17, like reference signs are given to like components of FIG. 9 to omit repeated description. Description for the configurations of the range imaging sensor 132 and the pixel circuit 421 is omitted because they are similar to those in the second embodiment shown in FIGS. 10 and 11.

The range image processing unit 104a controls the range imaging device 101a to calculate the distance to the object OB. The range image processing unit 104a measures a distance, as a measurement distance, to the object OB present in the measurement space based on the amount of charge integrated in the charge storage units CS. The range image processing unit 104a includes a timing control unit 141, a distance calculation unit 142a, and a measurement control unit 143a.

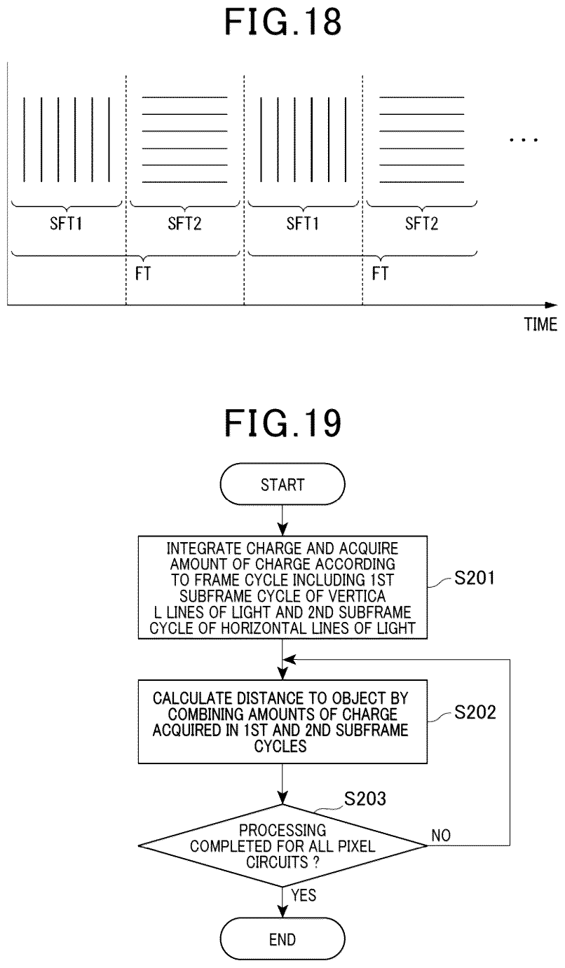

The present embodiment is similar to the second embodiment except that the processing performed by the distance calculation unit 142a and the measurement control unit 143a is different. The measurement control unit 143a uses the timing control unit 141 to control measurement of the distance to the object OB using a frame cycle FT including subframe cycles SFT. Herein, referring to FIG. 18, the frame cycle FT according to the present embodiment will be described.

FIG. 18 is a diagram illustrating an example of the frame cycle FT according to the present embodiment. As shown in FIG. 18, the frame cycle FT includes subframe cycles SFT (a subframe cycle SFT1 and a subframe cycle SFT2) in which the lines of light L are differently directed.

The subframe cycle SFT1 (first subframe cycle) is a subframe cycle SFT in which light pulses PO with lines of light L parallel to each other in the vertical direction are emitted. The subframe cycle SFT2 (second subframe cycle) is a subframe cycle SFT in which light pulses PO with lines of light L parallel to each other in the horizontal direction are emitted.

Thus, in the present embodiment, the light source unit 102 can emit structured light, as the light pulses PO, composed of periodically formed lines of light L in which lines of light L in two directions are perpendicular to each other. The measurement control unit 143a uses the timing control unit 141 to integrate charge and acquire the amount of charge according to the frame cycle FT including the subframe cycles SFT with the lines of light L in different directions. In the present embodiment, the subframe cycles SFT1 and SFT2 have the same integration period and readout period.

Referring back to FIG. 17, the distance calculation unit 142a calculates the distance to the object OB based on the amount of charge integrated according to the subframe cycles SFT of different line directions. For example, the distance calculation unit 142a may calculate the distance to the object OB based on the amount of charge obtained by combining the amount of charge acquired according to the subframe cycle SFT1 with the amount of charge acquired in the subframe cycle SFT2.

In the present embodiment, in the frame cycle FT, the light source unit 102 emits light pulses PO, as shown in FIG. 18, by alternately changing the lines of light L with different line directions on a subframe cycle SFT basis. The distance calculation unit 142a calculates the distance to the object OB based on the amount of charge integrated according to the subframe cycles SFT in which the line directions are alternately changed.

Referring to the drawings, an operation of the range imaging device 101a according to the present embodiment will be described. FIG. 19 is a flow chart illustrating an example of an operation of the range imaging device 101a according to the present embodiment. Herein, an example of calculation processing for the distance to the object OB will be described.

As shown in FIG. 19, the range imaging device 101a integrates charge and acquires the amount of charge, first, according to a frame cycle including the first frame cycle (subframe cycle SFT1) with vertical lines of light and the second subframe cycle (subframe cycle SFT2) with horizontal lines of light (S201). The measurement control unit 143a of the range imaging device 101a instructs the timing control unit 141 to integrate charge and acquire the amount of charge according to the frame cycle FT shown in FIG. 18, for example. In response to the control of the measurement control unit 143a, the timing control unit 141 integrates charge and acquires the amount of charge according to the frame cycle FT including the subframe cycles SFT1 and SFT2.

Next, the measurement control unit 143a instructs the distance calculation unit 142a to perform distance calculation processing, and the distance calculation unit 142a combines the amount of charge acquired in the first subframe cycle (subframe cycle SFT1) with the amount of charge acquired in the second subframe cycle (subframe cycle SFT2) to calculate the distance to the object OB (S202). For example, the distance calculation unit 142a may calculate the distance to the object OB by adding the amount of charge acquired in the subframe cycle SFT1 to the amount of charge acquired in the subframe cycle SFT2 using Formula (2) set forth above.

Next, the measurement control unit 143a determines whether the processing for all the pixel circuits 421 have been completed (S203). Specifically, the measurement control unit 143a determines whether the distance calculation processing for a single-frame cycle FT has been completed. If the processing for all the pixel circuits 421 has been completed (YES at S203), the measurement control unit 143a terminates the processing. If the processing for all the pixel circuits 421 has not been completed (NO at S203), the measurement control unit 143a allows processing to return to S202 to perform the distance calculation processing for the subsequent pixel circuit 421.

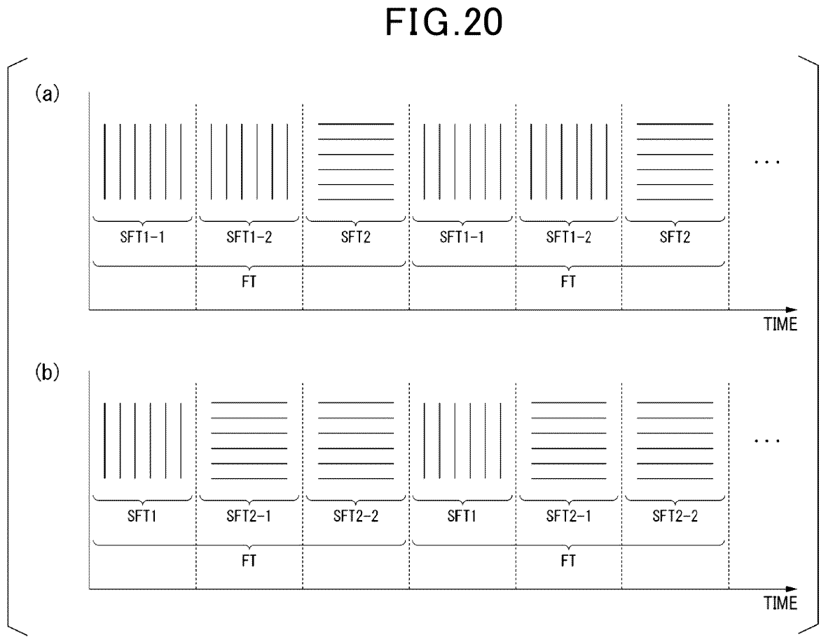

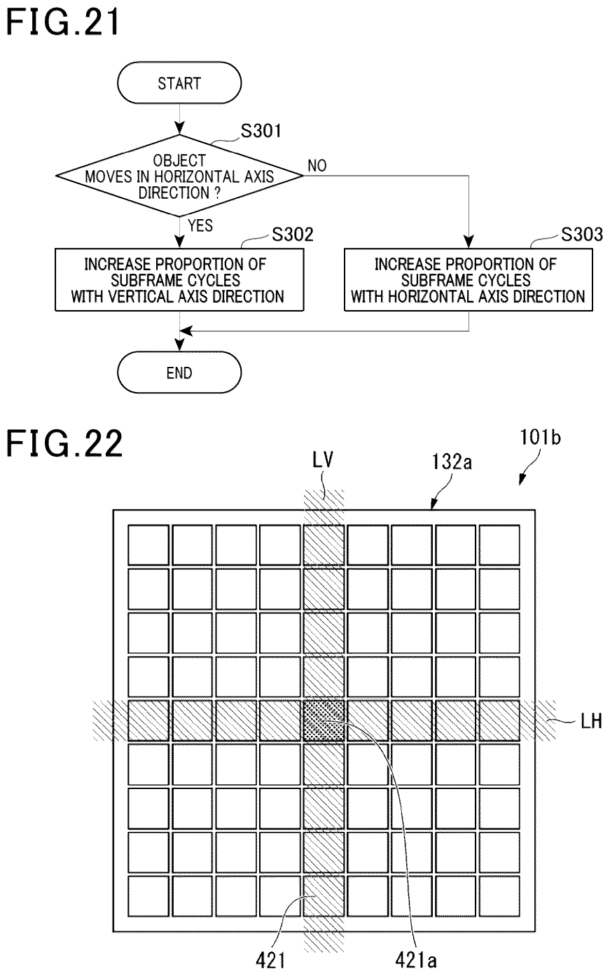

Referring to FIGS. 20 and 21, a modification of the range imaging device 101a according to the present embodiment will be described. FIG. 20 is a set of diagrams illustrating a modification of the frame cycle FT according to the present embodiment. In the modification shown in FIG. 20, a frame cycle FT includes three subframe cycles SFT.

In the present modification, the light source unit 102 changes the proportions of the subframe cycles SFT corresponding to the two directions of the lines of light L, among the subframe cycles SFT in the frame cycle FT, according to the direction of moving of the object OB, and accordingly emits the light pulses PO. Herein, in the frame cycle FT, the light source unit 102 changes the proportion of the subframe cycles SFT corresponding to the direction in which the amount of movement of the object OB is greater among the two directions, so that the changed proportion will be greater than the proportion of the subframe cycles SFT corresponding to the direction in which the amount of movement of the object OB is smaller, and accordingly emits the light pulses PO.

For example, FIG. 20(a) shows an example in which the object OB moves in the horizontal direction. As shown in FIG. 20(a), the frame cycle FT includes a subframe cycle SFT1-1 with vertical lines of light, a subframe cycle SFT1-2 with vertical lines of light, and a subframe cycle SFT2 with horizontal lines of light L.

In this case, since the object OB moves in the horizontal direction, the proportion of the subframe cycles SFT1 with vertical lines of light is increased, so that the object OB can be easily detected, thereby improving the measurement accuracy.

FIG. 20(b) shows an example in which the object OB moves in the vertical direction. As shown in FIG. 20(b), the frame cycle FT includes a subframe cycle SFT1 with vertical lines of light, a subframe cycle SFT2-1 with horizontal lines of light, and a subframe cycle SFT2-2 with horizontal lines of light L.

In this case, since the object OB moves in the vertical direction, the proportion of the subframe cycles SFT2 with horizontal lines of light is increased, so that the object OB can be easily detected, thereby improving the measurement accuracy. In the present embodiment, the direction of moving of the object OB may be specified by the user, or may be determined based on the direction of moving derived from the image information to be measured.

Referring to FIG. 21, the processing of changing the proportions of the subframe cycles SFT performed by the range imaging device 101a of the present embodiment will be described. FIG. 21 is a flow chart illustrating an example of an operation of the range imaging device 101a according to the present embodiment. The description herein is provided for the processing of changing the proportions of the subframe cycles SFT according to the direction of moving of the object OB.

As shown in FIG. 21, the measurement control unit 143a of the range imaging device 101a determines whether the direction of moving of the object OB is the horizontal direction (S301). If the direction of moving of the object OB is the horizontal direction (YES at S301), the measurement control unit 143a allows processing to proceed to S302. If the direction of moving of the object OB is not the horizontal direction (is the vertical direction) (NO at S301), the measurement control unit 143a allows processing to proceed to S303.

At S302, the measurement control unit 143a increases the proportion of the subframe cycles SFT1 of the vertical direction. The measurement control unit 143a controls the timing control unit 141 and, as shown in FIG. 20(a), increases the proportion of the subframe cycles SFT1 of the vertical direction (vertical lines of light), for example. Following the processing at S302, the measurement control unit 143a terminates the processing.

At S303, the measurement control unit 143a increases the proportion of the subframe cycles SFT2 of the horizontal direction. The measurement control unit 143a controls the timing control unit 141 and, as shown in FIG. 20(b), increases the proportion of the subframe cycles SFT2 of the horizontal direction (horizontal lines of light), for example. Following the processing at S303, the measurement control unit 143a terminates the processing.

As described above, the range imaging device 101a according to the present embodiment includes the light source unit 102, the light-receiving unit 103, and the distance calculation unit 142a. The light source unit 102 emits light pulses PO to the object OB. The light-receiving unit 103 includes the pixel circuits 421, the pixel drive circuit 422, and the charge discharge transistor GD (charge discharge section). The pixel circuits 421 formed in a two-dimensional matrix each includes the photoelectric conversion element PD generating charge corresponding to incident light and the charge storage units CS integrating the charge. The pixel drive circuit 422 distributes charge to the charge storage units CS for integration therein at the integration timing synchronized with the emission of the light pulses PO according to the frame cycle FT. The charge discharge transistor GD (charge discharge section) discharges charge in the period other than the integration timing. The distance calculation unit 142a calculates the distance to the object OB based on the amount of charge integrated in the charge storage units CS. Thus, the light source unit 102 can emit structured light, as the light pulses PO, composed of periodically formed lines of light L in which lines of light L in two directions are perpendicular to each other. The frame cycle FT includes subframe cycles SFT with lines of light L in different directions (e.g., subframe cycles SFT1 with vertical lines of light and subframe cycles SFT2 with horizontal lines of light). The distance calculation unit 142a calculates the distance to the object OB based on the amount of charge integrated according to the subframe cycles SFT of different line directions.

Thus, the range imaging device 101a of the present embodiment uses the amount of charge integrated in each of the subframe cycles SFT of different line directions (e.g., subframe cycles SFT1 with vertical lines of light and subframe cycles SFT2 with horizontal lines of light). Since emission occurs in one direction in a subframe cycle SFT in the range imaging device 101a of the present embodiment, the amount of charge (light intensity) will not be saturated at the intersections of lines of light L as in the case where the lines of light L are simultaneously emitted in two directions. Accordingly, the range imaging device 101a of the present embodiment can mitigate the signal output difference between the intersections of the lines of flight L and portions other than the intersections, and can improve resolution of the entire range image and suppress reduction in measurable distance.

In the present embodiment, in the frame cycle FT, the light source unit 102 emits light pulses PO by alternately changing the lines of light L with different line directions on a subframe cycle SFT basis. For example, the light source unit 102 emits light by alternating vertical lines of light in the subframe cycle SFT1, with horizontal lines of light in the subframe cycle SFT2. The distance calculation unit 142a calculates the distance to the object OB based on the amount of charge integrated according to the subframe cycles SFT in which the line directions are alternately changed.

Thus, the range imaging device 101a of the present embodiment emits the light pulses PO by alternately changing the lines of light L with different line directions on a subframe cycle SFT basis, and calculates the distance to the object OB based on the amount of charge integrated. Therefore, the effects achieved are equivalent to the effects achieved in the case where the lines of light L with different line directions are simultaneously emitted (e.g., the case of the second embodiment), and thus deterioration in resolution can be suppressed, while suppressing required light source output.

In the present embodiment, the light source unit 102 changes the proportions of the subframe cycles SFT corresponding to the lines of light L in the two directions, among the frame cycles FT, according to the direction of moving of the object OB, and accordingly emits the light pulses PO. For example, in the frame cycle FT, the light source unit 102 may change the proportion of the subframe cycles SFT corresponding to the direction in which the amount of movement of the object OB is greater among the two directions, so that the changed proportion will be greater than the proportion of the subframe cycles SFT corresponding to the direction in which the amount of movement of the object OB is smaller, and may accordingly emit the light pulses PO. Thus, the range imaging device 101a of the present embodiment can easily detect the moving object OB and can enhance the measurement accuracy.

The range imaging method of the present embodiment is a method for the range imaging device 101a including the light source unit 102, light-receiving unit 103, and distance calculation unit 142a described above. In the range imaging method, the light source unit 102 can emit structured light, as the light pulses PO, composed of periodically formed lines of light L in which lines of light L in two directions are perpendicular to each other. The frame cycle FT includes subframe cycles SFT with the lines of light L in different directions. The distance calculation unit 142a calculates the distance to the object OB based on the amount of charge integrated according to the subframe cycles SFT of different line directions. Thus, the range imaging method of the present embodiment can achieve effects similar to those of the range imaging device 101a described above, and thus can suppress deterioration in resolution, while suppressing required light source output.

### Fourth Embodiment

Referring to the drawings, a range imaging device 101b according to a fourth embodiment will be described. The fourth embodiment describes a method in which the pixel circuits 421 at positions corresponding to the intersections of the lines of light L are replaced by circuits preventing saturation.

FIG. 22 is a diagram illustrating an example of the range imaging device 101b according to the fourth embodiment. FIG. 22 illustrates a configuration example of a range imaging sensor 132a according to the present embodiment. Since the configuration other than the range imaging sensor 132a in the present embodiment is similar to the second embodiment, the description is omitted.

In FIG. 22, reflected light LH indicates the reflected light of the lines of light L in the horizontal direction, and reflected light LV indicates reflected light of the lines of light L in the vertical direction. A pixel circuit 421a (first pixel circuit) indicates a pixel circuit at a position corresponding to the position at which reflected light arising from the lines of light L emitted to the object OB in an intersecting manner is received from the object OB (intersection of reflected light), and pixel circuits 421 indicate pixel circuits at positions corresponding to the positions of other pixel circuits (second pixel circuits).

The pixel circuit 421a (first pixel circuit), which is provided with a sensitivity suppressor, is formed to have lower sensitivity to reflected light, compared to the pixel circuits 421 (second pixel circuits) at other positions. For example, as the sensitivity suppressor, the pixel circuit 421a may include a filter layer formed thereon, for reflection or absorption of part of the reflected light. For example, the filter layer may be formed to reduce the sensitivity of the pixel circuit 421a to ½ or less the sensitivity of the pixel circuits at other positions. Herein, for example, the filter layer may be an organic thin film absorbing part of the reflected light using techniques such as photolithography.

As the sensitivity suppressor, the capacitances of the charge storage units CS of the pixel circuit 421a (first pixel circuit) may be greater than the capacitances of the charge storage units CS of each pixel circuit 421 (second pixel circuit). In other words, charge storage capacitances C1 to C4 of the pixel circuit 421a shown in FIG. 11 may be, for example, twice or more the capacitances of each pixel circuit 421.

As the sensitivity suppressor, the volume of the photoelectric conversion element PD of the pixel circuit 421a may be smaller than the volume of the photoelectric conversion element PD of each pixel circuit 421. In other words, the volume of the photoelectric conversion element PD of the pixel circuit 421a may be ½ or less the volume in each pixel circuit 421.

As the sensitivity suppressor, the number of distributions (number of integrations) in the frame cycle FT of the pixel circuit 421a may be less than the number of distributions (number of integrations) in the frame cycle FT of each pixel circuit 421. In other words, the number of distributions (number of integrations) in the pixel circuit 421a may be ½ or less of the number of distributions (number of integrations) of each pixel circuit 421.

In the operation of the range imaging device 101b of the present embodiment, the frame cycle FT does not include the subframe cycles SFT, but is configured as a single frame. In other words, the range imaging device 101b simultaneously emits the lines of light L in two perpendicular directions as the light pulses PO as shown in FIG. 14, and calculates a range image.

As described above, the range imaging device 101b according to the present embodiment includes the light source unit 102, the light-receiving unit 103, and the distance calculation unit 142. The light source unit 102 emits light pulses PO to the object OB. The light-receiving unit 103 includes the pixel circuits 421, the pixel drive circuit 422, and the charge discharge transistor GD (charge discharge section). The pixel circuits 421 formed in a two-dimensional matrix each includes the photoelectric conversion element PD generating charge corresponding to incident light, and charge storage units CS integrating the charge. The pixel drive circuit 422 distributes charge to the charge storage units CS for integration therein at the integration timing synchronized with the emission of the light pulses PO according to the frame cycle FT. The charge discharge transistor GD (charge discharge section) discharges charge in the period other than the integration timing. The distance calculation unit 142 calculates the distance to the object OB based on the amount of charge integrated in the charge storage units CS. The light source unit 102 emits the light pulses PO including structured light composed of periodically formed lines of light L, i.e., the light pulses PO in which lines of light L in two directions are perpendicular to each other. Of the pixel circuits 421, the pixel circuit 421a (first pixel circuit) at a position corresponding to the position at which reflected light arising from the lines of light L emitted to the object OB in an intersecting manner has a sensitivity to reflected light which is lower than the sensitivity of each of the pixel circuits 421 at other positions (second pixel circuits).

Thus, in the range imaging device 101b of the present embodiment, since the sensitivity to reflected light of the pixel circuit 421a (first pixel circuit) is lower than the sensitivity of each of the pixel circuits 421 at other positions (second pixel circuits), saturation in the amount of charge (light intensity) can be suppressed at the intersection of the lines of light L. Accordingly, the range imaging device 101b of the present embodiment can mitigate the signal output difference between the intersections of the lines of flight L and portions other than the intersections, and can improve resolution of the entire range image and suppress reduction in measurable distance. The range imaging device 101b of the present embodiment can suppress deterioration in resolution, while suppressing required light source output, by using the lines of light L.

The pixel circuit 421a (first pixel circuit) of the range imaging device 101b of the present embodiment includes a filter layer formed thereon, for reflection or absorption of part of the reflected light. Thus, the range imaging device 101b of the present embodiment can more appropriately reduce the sensitivity to reflected light of the pixel circuit 421a (first pixel circuit) even more than the sensitivity of each of the pixel circuits 421 at other positions (second pixel circuits).

In the present embodiment, the capacitances of the charge storage units CS of the pixel circuit 421a may be greater than the capacitances of the charge storage units CS of each pixel circuit 421 (second pixel circuit). Thus, in the range imaging device 101b of the present embodiment, since the capacitances of the charge storage units CS of the pixel circuit 421a are greater than the capacitances of the charge storage units CS of each pixel circuits 421 (second pixel circuits), the sensitivity to reflected light of the pixel circuit 421a can be more appropriately reduced even more than the sensitivity of each of the pixel circuits 421 at other positions (second pixel circuits).

In the present embodiment, the volume of the photoelectric conversion element PD of the pixel circuit 421a may be smaller than the volume of the photoelectric conversion element PD of the pixel circuit 421. Thus, in the range imaging device 101b of the present embodiment, since the volume of the photoelectric conversion element PD of the pixel circuit 421a is smaller than the volume of the photoelectric conversion element PD of each pixel circuit 421a, the light conversion performance of the pixel circuit 421a is low and thus the sensitivity to reflected light of the pixel circuit 421a can be more appropriately reduced even more than the sensitivity of each of the pixel circuits 421 at other positions (second pixel circuits).

In the present embodiment, the number of distributions (number of integrations) in the frame cycle FT of the pixel circuit 421a may be less than the number of distributions (number of integrations) in the frame cycle FT of each pixel circuit 421.

Thus, in the range imaging device 101b of the present embodiment, the number of distributions (number of integrations) of the pixel circuit 421a is less than the number of distributions (number of integrations) of each pixel circuit 421, so that the sensitivity to reflected light of the pixel circuit 421a can be more appropriately reduced even more than the sensitivity of each of the pixel circuits 421 at other positions (second pixel circuits).

The present invention is not limited to the embodiments described above but can be modified in various ways without departing from the spirit of the present invention. The above embodiments have described examples in which each pixel circuit 421 (421a) includes four charge storage units CS (CS1, CS2, CS3 and CS4). However, without being limited to this, each pixel circuit 421 (421a) may include, for example, three or more, i.e., N, charge storage units CS.

The above embodiments have described examples in which the range image processing unit 104 (104a) is provided on the inside of the range imaging device 101 (101a, 101b). However, without being limited to this, the range image processing unit 104 (104a) may be provided on the outside of the range imaging device 101 (101a, 101b).

The above embodiments have described examples in which the photoelectric conversion element PD is an embedded type photodiode that performs photoelectric conversion for incident light and integrates the generated charge. However, without being limited to this, the photoelectric conversion element PD may be optionally structured. The photoelectric conversion element PD may be, for example, a PN photodiode including a P-type semiconductor and an N-type semiconductor joined together, or may be a PIN photodiode including an I-type semiconductor sandwiched between a P-type semiconductor and an N-type semiconductor. Alternatively, without being limited to a photodiode, the photoelectric conversion element PD may be, for example, a photogate-type photoelectric conversion element.

The second embodiment has described an example in which the frame cycle FT includes two subframe cycles SFT with different integration periods. However, without being limited to this, the frame cycle FT may include three or more subframe cycles SFT.

The third embodiment has described an example in which one subframe cycle SFT1-2 (or subframe cycle SFT2-2) is added when increasing the proportion of the subframe cycles SFT; however, two or more subframe cycles may be added.

The range imaging device 101 (101a, 101b) described above includes a computer system therein for the components. Programs for achieving the functions of the components included in the range imaging device 101 (101a, 101b) may be recorded on a computer readable recording medium, and a computer system may be caused to read and execute the programs recorded on the recording medium to perform the processing of the components included in the range imaging device 101 (101a, 101b). Herein, the expression “a computer system may be caused to read and execute the programs recorded on the recording medium” includes installing the programs on the computer system. The computer system referred to herein may include an OS and hardware components such as peripheral devices.

The computer system may also include computer devices that are connected thereto by way of a network such as the Internet, WAN or LAN, or network including communication lines such as dedicated lines, etc. The computer readable recording medium refers to a storage device such as a portable medium, e.g., a flexible disk, magneto-optical disk, ROM, CD-ROM, etc., or a hard disk incorporated in the computer system. In this way, the recording medium storing the programs may be a non-transitory recording medium such as a CD-ROM, etc.

The recording medium may also include an internally or externally provided recording medium which is accessible from the distribution server in order to distribute the programs. A program may be divided into segments and downloaded at different timings, followed by combining the segments in the components provided to the range imaging device 101 (101a, 101b), or different distribution servers may be used for distributing the segments. The computer readable recording medium may also include a recording medium temporarily storing programs, such as a volatile memory (RAM) inside a server in the case of transmitting programs via a network or inside a computer system different from the client's computer system. The programs may be those which achieve part of the functions described above. The programs may be those which can achieve the functions described above in combination with the programs already recorded on the computer system, i.e., so-called differential files (differential programs).

Part or all of the functions described above may be achieved in the form of an integrated circuit such as a large scale integration (LSI). The functions described above may be provided as separate processors, or part or all of the functions may be integrated and provided as a processor. The integrated circuit may be achieved by a dedicated circuit or a general-purpose processor, without being limited to an LSI. If an integrated circuit technology that can replace the LSI becomes available due to advances in semiconductor technology, an integrated circuit based on that technology may be used.

According to an embodiment of the present invention, deterioration can be suppressed in the resolution of the range image captured using a dot light source, and deterioration can be suppressed in the resolution of the entire range image and reduction can be suppressed in the measurable distance by mitigating the signal output difference between the intersections of the lines of light and portions other than the intersections.

Time of flight (“TOF”) type range imaging devices measure the distance between a measuring instrument and an object based on the time of flight of light in a space (measurement space), using the speed of light (e.g., see JP 4235729 B). In such a range imaging device, a delay from when light pulses are emitted until when the light reflected by the object returns is calculated by distributing and integrating charge, which corresponds to the intensity of reflected light incident on an imaging element, into charge storage units, and the distance to the object is calculated using the delay and the speed of light.

In a system for capturing an image based on the TOF method, one of the factors for determining the measurable maximum distance may be the power of measurement light source (irradiation intensity per unit area). The light source output can be increased by increasing the current flowing through the light-emitting elements; however, increase in current passed through the light-emitting elements leads to issues of increasing heat generation or power consumption in the imaging system, and reducing laser safety for humans.

To address the above issues, firstly, a dot light source may be used instead of a uniform-diffusion light source which is normally used as a distance measurement light source. Using a diffuser that converts the light emitted from the light source elements into periodically formed dots of light, the power of the light can be concentrated on the dots. Although the current passed through the light-emitting elements remains unchanged, use of a dot light source makes it possible to measure a longer distance than when using diffuse light that uniformly illuminates the illumination surface.

However, when measuring a distance using a dot light source, distances that can be measured are only for the areas illuminated with the dots of light, and distances cannot be measured for the areas between the dots, i.e., areas on the object where the illumination light is not applied. Thus, range images captured using a dot light source have an issue in that the resolution is lower than in range images captured using uniformly diffused light.

To address the above issues, secondly, linearly emitted light may be used instead of uniformly diffused light which is normally used as distance measurement light. For example, two groups of light each composed of parallel lines of light may be emitted so that one group of lines of light is perpendicular to the other group of lines of light to suppress deterioration in resolution, while suppressing required light source output, compared to the case where range images are captured using uniformly diffused light.

However, in the above method using lines of light, the brightness at the intersections of the perpendicular lines of light is twice as bright as the brightness of the lines of light in other portions, resulting in the output of the pixels corresponding to the intersections being saturated and the distance measurement not necessarily being performed. On the other hand, if the output is reduced to avoid saturation, the above method using lines of light may result in deterioration in resolution in the linear portions other than the intersections and decrease in the measurable distance.

A range imaging device and a range imaging method according to embodiments of the present invention suppress deterioration in resolution of a range image captured using a dot light source and mitigate signal output difference between the intersections of the lines of light and portions other than the intersections, suppressing deterioration in the overall range image, and suppressing decrease in measurable distance.

A range imaging device according to a first aspect of the present invention includes a light source unit emitting light pulses to an object; a light-receiving unit including pixel circuits formed in a two-dimensional matrix, each of the pixel circuits including a photoelectric conversion element generating charge according to incident light and charge storage units integrating the charge, a pixel drive circuit distributing the charge to the charge storage units for integration therein at an integration timing synchronized with the emission of the light pulses, and a charge discharge unit discharging the charge during a period other than the integration timing; and a distance calculation unit calculating a distance to the object based on an amount of charge integrated in the charge storage units. The light pulses include structured light having patterns of dot light; and at least one first pattern of dot light among the patterns of dot light has an elliptical shape in which a ratio of a major axis length to a minor axis length is a threshold or more.

In the range imaging device according to the first aspect, at least part of the first pattern of dot light may be overlapped with at least part of another pattern of dot light adjacent to the first pattern of dot light in a major axis direction.

In the range imaging device according to the first aspect, the light source unit may include light source elements each of which can independently emit the light pulses.

In the range imaging device, elliptical patterns of dot light emitted from one of at least two of the light source elements may have a major axis direction different from a major axis direction of elliptical patterns of dot light emitted from the other thereof.

In the range imaging device, elliptical patterns of dot light emitted from one of at least two of the light source elements may have a major axis direction perpendicular to a major axis direction of elliptical patterns of dot light emitted from the other thereof.

In the range imaging device, elliptical patterns of dot light with the major axes oriented in the same direction emitted from a first light source element group composed of at least two light source elements among the light source elements may have a first interval in a minor axis direction, and elliptical patterns of dot light with the major axes oriented in the same direction emitted from a second light source element group different from the first light source element group and composed of at least two light source elements among the light source elements may have a second interval in a minor axis direction, and the first interval and the second interval are different from each other.

In the range imaging device, the elliptical patterns of dot light emitted from at least two light source elements among the light source elements may have major axis directions which are oblique, instead of perpendicular or parallel, relative to a surface on which the imaging device is installed.

In the range imaging device, the elliptical patterns of dot light emitted from two light source elements among the light source elements may have major axis directions at an angle of 45 degrees or 135 degrees relative to a surface on which the imaging device is installed.

In the range imaging device, at least one of the light source elements may be a diffuse light source.

A range imaging method according to a second aspect of the present invention is performed by a range imaging device including a light source unit emitting light pulses to an object; a light-receiving unit including pixel circuits formed in a two-dimensional matrix, each of the pixel circuits including a photoelectric conversion element generating charge according to incident light and charge storage units integrating the charge, a pixel drive circuit distributing the charge to the charge storage units for integration therein at an integration timing synchronized with the emission of the light pulses, and a charge discharge unit discharging the charge during a period other than the integration timing; and a distance calculation unit calculating a distance to the object based on an amount of charge integrated in the charge storage units. The light pulses include structured light including patterns of dot light; and at least one first pattern of dot light among the patterns of dot light has an elliptical shape in which a ratio of a major axis length to a minor axis length is a threshold or more.

A range imaging device according to a third aspect of the present invention includes a light source unit emitting light pulses to an object; a light-receiving unit including pixel circuits formed in a two-dimensional matrix, each of the pixel circuits including a photoelectric conversion element generating charge according to incident light and charge storage units integrating the charge, a pixel drive circuit distributing the charge to the charge storage units for integration therein at an integration timing synchronized with the emission of the light pulses according to a frame cycle, and a charge discharge unit discharging the charge during a period other than the integration timing; and a distance calculation unit calculating a distance to the object based on an amount of charge integrated in the charge storage units. The light source unit emits the light pulses including structured light composed of periodically formed lines of light, the light pulses including the lines of light in two directions intersecting with each other; the frame cycle includes subframe cycles with different integration periods for integrating the charge in the charge storage units; and the distance calculation unit calculates a distance to the object using a subframe cycle in which the amount of charge has not exceeded a preset threshold, among the subframe cycles.

In the range imaging device, the subframe cycles may include a first subframe cycle of which the integration period is a preset period, and a second subframe cycle of which the integration period is equal to or greater than twice the preset period; and the distance calculation unit calculates a distance to the object using a subframe cycle in which the amount of charge has not exceeded the threshold and the integration period is longer, among the first subframe cycle and the second subframe cycle.

A range imaging device according to a fourth aspect of the present invention includes a light source unit emitting light pulses to an object; a light-receiving unit including pixel circuits formed in a two-dimensional matrix, each of the pixel circuits including a photoelectric conversion element generating charge according to incident light and charge storage units integrating the charge, a pixel drive circuit distributing the charge to the charge storage units for integration therein at an integration timing synchronized with the emission of the light pulses according to a frame cycle, and a charge discharge unit discharging the charge during a period other than the integration timing; and a distance calculation unit calculating a distance to the object based on an amount of charge integrated in the charge storage units. The light source unit emits the lines of light as the light pulses including structured light including periodically formed lines of light, the light pulses including the lines of light in two directions intersecting with each other; the frame cycle includes subframe cycles including the lines of light with different directions; and the distance calculation unit calculates a distance to the object based on the amount of charge integrated according to the subframe cycles including the lines of light with different directions.

In the range imaging device, in the frame cycle, the light source unit may emit the light pulses by alternately changing the lines of light with different line directions on a subframe cycle basis; and the distance calculation unit calculates a distance to the object based on the amount of charge integrated according to the subframe cycles in which the direction of the lines of light is alternately changed.

In the range imaging device, in the frame cycle, the light source unit may change proportions of the subframe cycles corresponding to the lines of light in the two directions, among the subframe cycles, according to a direction of moving of the object, and accordingly emits the light pulses.

In the range imaging device, in the frame cycle, the light source unit changes the proportion of the subframe cycles corresponding to the direction in which the amount of movement of the object is greater among the two directions, so that the changed proportion is greater than the proportion of the subframe cycles corresponding to the direction in which the amount of movement of the object is smaller, and accordingly emits the light pulses.

In the range imaging device, the light source unit may include light source elements which can independently emit the light pulses; and the lines of light are formed by discretely emitting patterns of dot light in a line, or by emitting the patterns of dot light in a line so as to overlap with each other, from the light source elements.

In the range imaging device according to the seventeenth aspect, each pattern of dot light may have an elliptical shape in which a ratio of a major axis length to a minor axis length is 2 or greater; and each line of light may be formed in a line along a major axis direction.

In a range imaging method according to a fifth aspect of the present invention, a range imaging device includes a light source unit emitting light pulses to an object; a light-receiving unit including pixel circuits formed in a two-dimensional matrix, each of the pixel circuits including a photoelectric conversion element generating charge according to incident light and charge storage units integrating the charge, a pixel drive circuit distributing the charge to the charge storage units for integration therein at an integration timing synchronized with the emission of the light pulses according to a frame cycle, and a charge discharge unit discharging the charge during a period other than the integration timing; and a distance calculation unit calculating a distance to the object based on an amount of charge integrated in the charge storage units. The light source unit emits the light pulses including structured light including periodically formed lines of light, the light pulses including the lines of light in two directions intersecting with each other; the frame cycle includes subframe cycles with different integration periods for integrating the charge in the charge storage units; and the distance calculation unit calculates a distance to the object using a subframe cycle in which the amount of charge has not exceeded a preset threshold, among the subframe cycles.

In a range imaging method according to a sixth aspect of the present invention, a range imaging device includes a light source unit emitting light pulses to an object; a light-receiving unit including pixel circuits formed in a two-dimensional matrix, each of the pixel circuits including a photoelectric conversion element generating charge according to incident light and charge storage units integrating the charge, a pixel drive circuit distributing the charge to the charge storage units for integration therein at an integration timing synchronized with the emission of the light pulses according to a frame cycle, and a charge discharge unit discharging the charge during a period other than the integration timing; and a distance calculation unit calculating a distance to the object based on an amount of charge integrated in the charge storage units. The light source unit emits the lines of light as the light pulses including structured light composed of periodically formed lines of light, the light pulses including the lines of light in two directions intersecting with each other; the frame cycle includes subframe cycles including the lines of light with different directions; and the distance calculation unit calculates a distance to the object based on the amount of charge integrated according to the subframe cycles including the lines of light with different directions.

A range imaging device according to a seventh aspect of the present invention includes a light source unit emitting light pulses to an object; a light-receiving unit including pixel circuits formed in a two-dimensional matrix, each of the pixel circuits including a photoelectric conversion element generating charge according to incident light and charge storage units integrating the charge, a pixel drive circuit distributing the charge to the charge storage units for integration therein at an integration timing synchronized with the emission of the light pulses according to a frame cycle, and a charge discharge unit discharging the charge during a period other than the integration timing; and a distance calculation unit calculating a distance to the object based on an amount of charge integrated in the charge storage units. The light source unit emits the light pulses including structured light including periodically formed lines of light, the light pulses including the lines of light in two directions intersecting with each other; and of the pixel circuits, a first pixel circuit at a position corresponding to a position of receiving reflected light from the object arising from the lines of light emitted in an intersecting manner has a sensitivity to the reflected light that is lower than a sensitivity of each of second pixel circuits at other positions.

The range imaging device may include a filter layer formed on the first pixel circuit to reflect or absorb part of the reflected light.

In the range imaging device, the charge storage units of the first pixel circuit may have capacitances that is greater than capacitances of the charge storage units of each of the second pixel circuits.

In the range imaging device, the photoelectric conversion element of the first pixel circuit may have a volume that is smaller than a volume of the photoelectric conversion element of each of the second pixel circuits.

In the range imaging device, the number of distributions performed by the first pixel circuit in the frame cycle may be smaller than the number of distributions performed by each of the second pixel circuits in the frame cycle.

In the range imaging device, the light source unit may include light source elements which independently emit the light pulses; and the lines of light are formed by discretely emitting patterns of dot light in a line, or by emitting the patterns of dot light in a line so as to overlap with each other, from the light source elements.

In the range imaging device, each pattern of dot light may have an elliptical shape in which a ratio of a major axis length to a minor axis length is 2 or greater; and each line of light may be formed in a line along a major axis direction.

According to an embodiment of the present invention, deterioration can be suppressed in the resolution of the range image captured using a dot light source, and deterioration can be suppressed in the resolution of the entire range image and reduction can be suppressed in the measurable distance by mitigating the signal output difference between the intersections of the lines of light and portions other than the intersections.

Obviously, numerous modifications and variations of the present invention are possible in light of the above teachings. It is therefore to be understood that within the scope of the appended claims, the invention may be practiced otherwise than as specifically described herein.

1. A range imaging device, comprising
a light source configured to emit light pulses to an object;
a light-receiving unit comprising a plurality of pixel circuits, a pixel drive circuit, and a charge discharge unit; and
a distance calculation unit comprising circuitry configured to calculate a distance to the object,
wherein the plurality of pixel circuits is formed in a two-dimensional matrix, each of the pixel circuits includes a photoelectric conversion element configured to generate charge according to incident light and a plurality of charge storage units configured to integrate the charge, the pixel drive circuit is configured to distribute the charge to the charge storage units at an integration timing synchronized with emission of the light pulses, the charge discharge unit discharges the charge during a period other than the integration timing, the circuitry of the distance calculation unit is configured to calculate the distance to the object based on an amount of the charge integrated in the charge storage units, and the light pulses comprise structured light having a plurality of patterns of dot light such that the plurality of patterns of dot light includes at least one first pattern of dot light having an elliptical shape in which a ratio of a major axis length to a minor axis length is equal to a threshold or more.

2. The range imaging device according to claim 1, wherein at least part of the first pattern of dot light is overlapped with at least part of another pattern of dot light adjacent to the first pattern of dot light in a major axis direction.

3. The range imaging device according to claim 1, wherein the light source includes a plurality of light source elements each configured to independently emit the light pulses.

4. The range imaging device according to claim 3, wherein one of at least two of the plurality of light source elements is configured to emit elliptical patterns of dot light having a major axis direction different from a major axis direction of elliptical patterns of dot light emitted from the other.

5. The range imaging device according to claim 4, wherein one of at least two of the plurality of light source elements is configured to emit elliptical patterns of dot light having a major axis direction perpendicular to a major axis direction of elliptical patterns of dot light emitted from the other.

6. The range imaging device according to claim 5, wherein elliptical patterns of dot light with the major axes oriented in the same direction emitted from a first light source element group comprising at least two light source elements among the plurality of light source elements have a first interval in a minor axis direction, and elliptical patterns of dot light with the major axes oriented in the same direction emitted from a second light source element group different from the first light source element group and comprising at least two light source elements among the plurality of light source elements have a second interval in a minor axis direction, and the first interval and the second interval are different from each other.

7. The range imaging device according to claim 5, wherein the elliptical patterns of dot light emitted from at least two light source elements among the plurality of light source elements have major axis directions which are oblique, instead of perpendicular or parallel, relative to a surface on which the imaging device is installed.

8. The range imaging device according to claim 7, wherein the elliptical patterns of dot light emitted from two light source elements among the plurality of light source elements have major axis directions at an angle of 45 degrees or 135 degrees relative to a surface on which the imaging device is installed.

9. The range imaging device according to claim 3, wherein at least one of the plurality of light source elements is a diffuse light source.

10. A range imaging device, comprising:
a light source is configured to emit light pulses to an object;
a light-receiving unit comprising a plurality of pixel circuits, a pixel drive circuit, and a charge discharge unit; and
a distance calculation unit comprising circuitry configured to calculate a distance to the object,
wherein the plurality of pixel circuits is formed in a two-dimensional matrix, each of the pixel circuits includes a photoelectric conversion element configured to generate charge according to incident light and a plurality of charge storage units configured to integrate the charge, the pixel drive circuit is configured to distribute the charge to the charge storage units at an integration timing synchronized with emission of the light pulses according to a frame cycle, the charge discharge unit discharges the charge during a period other than the integration timing, the circuitry of the distance calculation unit is configured to calculate a distance to the object based on an amount of the charge integrated in the charge storage units, the light source is configured to emit the light pulses comprising structured light comprising periodically formed lines of light such that the light pulses include the periodically formed lines of light in two directions intersecting with each other, the frame cycle includes a plurality of subframe cycles with different integration periods for integrating the charge in the charge storage units, and the circuitry of the distance calculation unit is configured to calculate the distance to the object using a subframe cycle in which the amount of the charge has not exceeded a preset threshold among the plurality of subframe cycles.

11. The range imaging device according to claim 10, wherein the plurality of subframe cycles comprise a first subframe cycle of which the integration period is a preset period, and a second subframe cycle of which the integration period is equal to or greater than twice the preset period, and the circuitry of the distance calculation unit is configured to calculate the distance to the object using a subframe cycle in which the amount of the charge has not exceeded the threshold and the integration period is longer among the first subframe cycle and the second subframe cycle.

12. A range imaging device, comprising:
a light source configured to emit light pulses to an object;
a light-receiving unit comprising a plurality of pixel circuits, a pixel drive circuit, and a charge discharge unit; and
a distance calculation unit comprising circuitry configured to calculate a distance to the object,
wherein the plurality of pixel circuits is formed in a two-dimensional matrix, each of the pixel circuits includes a photoelectric conversion element configured to generate charge according to incident light and a plurality of charge storage units configured to integrate the charge, the pixel drive circuit is configured to distribute the charge to the charge storage units at an integration timing synchronized with emission of the light pulses according to a frame cycle, the charge discharge unit discharges the charge during a period other than the integration timing, the circuitry of the distance calculation unit is configured to calculate the distance to the object based on an amount of the charge integrated in the charge storage units, the light source is configured to emit lines of light as the light pulses comprising structured light comprising periodically formed lines of light, the light pulses include the lines of light in two directions intersecting with each other, the frame cycle includes a plurality of subframe cycles including the formed lines of light with different directions, and the circuitry of the distance calculation unit is configured to calculate the distance to the object based on the amount of the charge integrated according to the plurality of subframe cycles including the lines of light with different directions.

13. The range imaging device according to claim 12, wherein in the frame cycle, the light source is configured emit the light pulses by alternately changing the lines of light with different line directions on a subframe cycle basis, and the circuitry of the distance calculation unit is configured to calculate the distance to the object based on the amount of the charge integrated according to the plurality of subframe cycles in which the direction of the lines of light is alternately changed.

14. The range imaging device according to claim 12, wherein in the frame cycle, the light source is configured to change proportions of the subframe cycles corresponding to the lines of light in the two directions among the plurality of subframe cycles according to a direction of moving of the object and accordingly emit the light pulses.

15. The range imaging device according to claim 14, wherein in the frame cycle, the light source is configured to change the proportion of the subframe cycles corresponding to the direction in which the amount of movement of the object is greater among the two directions such that the proportion is greater than the proportion of the subframe cycles corresponding to the direction in which the amount of movement of the object is smaller and accordingly emit the light pulses.

16. The range imaging device according to claim 10, wherein the light source includes a plurality of light source elements configured to independently emit the light pulses such that the lines of light are formed by discretely emitting a plurality of patterns of dot light in a line or by emitting the plurality of patterns of dot light in a line such that the patterns of dot light overlap with each other from the plurality of light source elements.

17. The range imaging device according to claim 16, wherein each of the patterns of dot light has an elliptical shape in which a ratio of a major axis length to a minor axis length is 2 or greater, and each of the lines of light is formed in a line along a major axis direction.

18. A range imaging device, comprising:
a light source configured to emit light pulses to an object;
a light-receiving unit comprising a plurality of pixel circuits, a pixel drive circuit, and a charge discharge unit; and
a distance calculation unit comprising circuitry configured to calculate a distance to the object,
wherein the plurality of pixel circuits is formed in a two-dimensional matrix, each of the pixel circuits includes a photoelectric conversion element configured to generate charge according to incident light and a plurality of charge storage units configured to integrate the charge, the pixel drive circuit is configured to distribute the charge to the charge storage units at an integration timing synchronized with emission of the light pulses according to a frame cycle, the charge discharge unit discharges the charge during a period other than the integration timing, the circuitry of the distance calculation unit is configured to calculate the distance to the object based on an amount of the charge integrated in the charge storage units, the light source is configured to emit the light pulses comprising structured light comprising periodically formed lines of light such that the light pulses include the periodically formed lines of light in two directions intersecting with each other, and the plurality of pixel circuits includes a first pixel circuit formed at a position corresponding to a position of receiving reflected light from the object arising from the periodically formed lines of light emitted in an intersecting manner and having a sensitivity to the reflected light that is lower than a sensitivity of each of second pixel circuits at other positions.

19. The range imaging device according to claim 18, further comprising:
a filter layer formed on the first pixel circuit and configured to reflect or absorb part of the reflected light.

20. The range imaging device according to claim 18, wherein the charge storage units of the first pixel circuit have capacitances that are greater than capacitances of the charge storage units of each of the second pixel circuits.

21. The range imaging device according to claim 18, wherein the photoelectric conversion element of the first pixel circuit has a volume that is smaller than a volume of the photoelectric conversion element of each of the second pixel circuits.

22. The range imaging device according to claim 18, wherein a number of distributions by the first pixel circuit in the frame cycle is smaller than a number of distributions by each of the second pixel circuits in the frame cycle.

23. The range imaging device according to claim 18, wherein the light source includes a plurality of light source elements configured to independently emit the light pulses such that the periodically formed lines of light are formed by discretely emitting a plurality of patterns of dot light in a line or by emitting the plurality of patterns of dot light in a line such that the patterns of dot light overlap with each other from the plurality of light source elements.

24. The range imaging device according to claim 23, wherein each of the patterns of dot light has an elliptical shape in which a ratio of a major axis length to a minor axis length is 2 or greater, and each of the periodically formed lines of light is formed in a line along a major axis direction.
